(19) United States
(12) Patent Application Publication
(10) Pub. No.: US 2015/0331240 A1
(43) Pub. Date: Nov. 19, 2015

(54) Assisted Viewing Of Web-Based Resources

(71) Applicants: Adam G. Poulos, Sammamish, WA (US); Cameron G. Brown, Bellevue, WA (US); Stephen G. Latta, Seattle, WA (US); Brian J. Mount, Seattle, WA (US); Daniel J. McCulloch, Kirkland, WA (US)

(72) Inventors: Adam G. Poulos, Sammamish, WA (US); Cameron G. Brown, Bellevue, WA (US); Stephen G. Latta, Seattle, WA (US); Brian J. Mount, Seattle, WA (US); Daniel J. McCulloch, Kirkland, WA (US)

(21) Appl. No.: 14/279,146

(22) Filed: May 15, 2014

(51) Int. Cl. G02B 27/01

(52) U.S. Cl. CPC G02B 27/017; G02B 27/0179; G02B 2027/0178; G02B 2027/0187

(57) ABSTRACT

Assisted viewing of web-based resources by an end user of a head-mounted display device (HMD) is described. An HMD may display content from web-based resources using a see-through display while tracking eye and head movement of the end user viewing the content within an augmented reality environment. Active view regions within the see-through display are identified based on tracking information including eye gaze data and head direction data. The web-based resources are analyzed to identify content and display elements. The analysis is correlated with the active view regions to identify the underlying content that is a desired point of focus of a corresponding active view region, as well as to identify the display elements corresponding to that content. A web-based resource is modified based on the correlation. The content from the web-based resource is displayed based on the modifications to assist the end user in viewing the web-based resource.

### BACKGROUND

The disclosed technology is related to displaying web-based resources.

Augmented reality (AR) relates to providing an augmented real-world environment where the perception of a real-world environment (or data representing a real-world environment) is augmented or modified with computer-generated virtual data. For example, data representing a real-world environment may be captured in real-time using sensory input devices such as a camera or microphone and augmented with computer-generated virtual data including virtual images and virtual sounds. The virtual data may also include information related to the real-world environment such as a text description associated with a real-world object in the real-world environment. The objects within an AR environment may include real objects (i.e., objects that exist within a particular real-world environment) and virtual objects (i.e., objects that do not exist within the particular real-world environment).

In order to realistically integrate virtual objects into an AR environment, an AR system typically performs several tasks including mapping and localization. Mapping relates to the process of generating a map of a real-world environment. Localization relates to the process of locating a particular point of view or pose relative to the map of the real-world environment. In some cases, an AR system may localize the pose of a mobile device moving within a real-world environment in real-time in order to determine the particular view associated with the mobile device that needs to be augmented as the mobile device moves within the real-world environment.

### SUMMARY

Technology for assisted viewing of web-based resources by an end user of a head-mounted display device (HMD) is described. An HMD may display content from web-based resources using a see-through display while tracking eye and head movement of the end user viewing the content within an augmented reality environment. Active view regions within the see-through display are identified based on tracking information including eye gaze data and head direction data. The web-based resources are analyzed to identify content and display elements. The analysis is correlated with the active view regions to identify the underlying content that is a desired point of focus corresponding to an active view region, as well as to identify the display elements corresponding to that content. A web-based resource is modified based on the correlation. The content from the web-based resource is displayed based on the modifications to assist the end user in viewing the web-based resource.

In one embodiment, an HMD correlates an end user's tracking information with the content being viewed to develop content preference information for the end user. The HMD uses tracking information to identify points of focus as the user views a plurality of web-based resources over time. The HMD can semantically analyze the content corresponding to the points of focus to develop content preferences for the end user. The content preferences based on tracking information can optionally be combined with explicitly provided user preferences. The content preferences can be used to modify web-based resources for display to the end user. For example, the HMD can prioritize content or provide visual indications of content that is determined to correlate to the end user's content preferences.

In one embodiment, an HMD uses tracking information and image capture data from the augmented reality environment to reposition or reflow content from web-based resources for assisted display. An augmented reality environment may include real objects and/or virtual objects. The HMD can detect when an end user's view of content from a web-based resource may be obstructed by an object. The HMD can analyze the web-based resource from which the content is derived. The resource can be modified, by changing or adding display elements for example, to reposition or reflow the content in the augmented reality environment to assist in viewing by the end user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of one embodiment of a networked computing environment in which the disclosed technology may be practiced.

FIG. 2A depicts one embodiment of a mobile device in communication with a second mobile device.

FIG. 2B depicts one embodiment of a portion of an HMD.

FIG. 2C depicts one embodiment of a portion of an HMD in which gaze vectors extending to a point of gaze are used for aligning a far inter-pupillary distance (IPD).

FIG. 2D depicts one embodiment of a portion of an HMD in which gaze vectors extending to a point of gaze are used for aligning a near inter-pupillary distance (IPD).

FIG. 3A depicts one embodiment of a portion of an HMD with movable display optical systems including gaze detection elements.

FIG. 3B depicts an alternative embodiment of a portion of an HMD with movable display optical systems including gaze detection elements.

FIG. 4A depicts one embodiment of an HMD worn by an end user viewing a virtual content reader within an augmented reality environment.

FIG. 4B depicts one embodiment of an HMD worn by an end user viewing a virtual content reader within an augmented reality environment.

FIG. 5 is a flowchart describing one embodiment of a method for displaying content using an HMD.

FIG. 6 depicts one embodiment of an HMD worn by an end user viewing a virtual content reader within an augmented reality environment.

FIG. 7A is a flowchart describing one embodiment of a method for displaying content using an HMD and generating user content preference information.

FIG. 7B is a flowchart describing one embodiment of a method for displaying content using an HMD and user content preference information.

FIG. 8A depicts one embodiment of an HMD worn by an end user viewing a virtual content reader within an augmented reality environment.

FIG. 8B depicts one embodiment of an HMD worn by an end user viewing a virtual content reader within an augmented reality environment.

FIG. 9A depicts one embodiment of an HMD worn by an end user viewing a virtual content reader within an augmented reality environment.

FIG. 9B depicts one embodiment of an HMD worn by an end user viewing a virtual content reader within an augmented reality environment.

FIG. 10 is a flowchart describing one embodiment of a method for displaying content using an HMD and a modified web-based resource.

FIG. 11 depicts one embodiment of an HMD worn by an end user viewing a virtual content reader within an augmented reality environment.

FIG. 12 is a flowchart describing one embodiment of a method for displaying content using an HMD and providing automatic content scrolling.

FIG. 13 is a block diagram of one embodiment of a mobile device.

### DETAILED DESCRIPTION

Technology is described for controlling the display of content as the content is being viewed on a head-mounted display device (HMD) by an end user. The content may comprise text, images, and/or video associated with web-based resources such as a webpage, electronic book, or electronic magazine, for example. In some embodiments, an HMD may display the content using a virtual content reader (VCR) for reading the content.

The HMD includes technologies that assist in reading or otherwise viewing web-based resources. The HMD can utilize eye tracking and/or head tracking in combination with an analysis of a web-based resource from which content is being displayed to enhance the display of the content. The HMD may display content from a web-based resource while tracking eye and/or head movement of the user wearing the HMD to generate tracking information including user gaze data and head direction data. From the tracking information, the HMD determines an active view region of the display of the HMD as corresponding to a user's desired point of focus. The HMD utilizes the desired point of focus to enhance the display of the content.

In one embodiment, the HMD analyzes the web-based resource from which the content is derived to determine how to enhance the content. In this manner, the HMD is able to analyze the web-based resource to intelligently identify portions of the content as corresponding to the user's desired point of focus. For instance, the HMD may analyze the web-based resource to identify portions of the content as well as display elements as having a correspondence to the user's desired point of focus. Elements such as hypertext markup language (HTML) elements and cascading style sheet (CSS) elements from the web-based resource may be identified, in addition to the content corresponding to these elements. The HMD may modify these elements, add additional elements, and/or modify other elements of the webpage to enhance the content corresponding to the user's desired point of focus. By way of example, the HMD can automatically highlight text that a reader is reading, for example by identifying an article or other content within a webpage as a point of focus. This may include highlighting the article, and within the article highlighting or identifying already-read text and/or unread text. The HMD may analyze the web-based resource to determine a webpage's hierarchy for example, to identify HTML elements such as “table” and “DIV” elements corresponding to the article being read. In this manner, the HMD can limit highlighting based on the underlying resource elements to limit highlighting to the desired article or active region without “spilling over” to text within nearby articles within the webpage. User reading statistics and other information may be used to identify points of focus, to minimize false positives for example, where a user's view passes through or across an article but the user did not intend to read the article.

In one embodiment, the HMD uses tracking information in combination with knowledge of a web-based resource's hierarchy to prioritize content within the resource based on the user. For example, the HMD may generate content preference information for a user based on the user's gaze information when viewing content. When displaying a web-based resource, the HMD may analyze the resource to determine its hierarchy. This may include identifying various HTML and CSS elements to parse a webpage into a set of articles from the webpage. The HMD can semantically analyze the content of the different articles. The article content can be compared with the user's content preference information to determine a correlation between the two for each article. The HMD can then modify the web-based resource so that articles that correlate more closely to the user's content preference information are prioritized over articles that correlate less closely to the user's content preference information. Modifying the resource may include modifying HTML or CSS elements to re-present an order of the articles or to prioritize the articles based on the user's content preference information. The HMD may also use explicitly provided preference information from a user to prioritize articles within a web-based resource.

In one embodiment, the HMD provides a visual notification in the display region when content from a web-based resource is displayed. The HMD may pre-process the resource before display to determine a number of articles that the user may be interested in based on their content preferences. The visual notification may provide an indication of the number of such articles. The HMD can use eye and head tracking to determine when the user reads (e.g., begins reading or completes reading) one of the prioritized articles. The visual notification can be updated to reflect the remaining number of articles that were determined to match or otherwise correlate with the user's content preferences. A visual indication of a prioritized article can also be provided, for example by providing a border or other visual highlight in association with the article.

In one embodiment, the HMD uses the web-based resource's hierarchy, including links to and from other resources in a hierarchical format, to show relevant information or highlight more relevant information out of a user's current field of view. The HMD may use positional sound data to provide visual and/or auditory highlights. In one example, position sound is used through a head relative transfer function to signal a location of relevant content and the relevance of the additional content to the content currently viewed.

In one embodiment, the HMD automatically scrolls content from web-based resources. For example, head direction and view direction stability may be used to detect that a user is reading a particular article or portion within a web page, for example. The player's history of scrolling content may be used to determine a user-specific scrolling rate. When the user begins reading a portion of the content, that portion may begin scrolling at the user's scrolling rate. The user's scrolling rate may change over time as the HMD generates additional data from gaze information generated from the scrolling behavior of the user over time. The HMD may combine automatic scrolling of content with user controlled scrolling.

In one embodiment, the HMD analyzes the content from a web-based resource using a complexity analysis to determine a reading level of the content. The HMD can use the results of the complexity analysis to adjust the automatic scrolling rate. For example, the user's scrolling speed may be used for content determined to have a baseline of complexity. The scrolling rate can be increased for content having a lower complexity and decreased for content having a higher complexity. The system may update a user's scrolling rate based on actions taken during scrolling, such as stopping, cancelling, or manually adjusting the scrolling rate. Voice navigation can be used to further control scrolling. Additionally, the reader's known reading level may be stored by the device and used to provide an initial scrolling rate for content based on the complexity of the current content. For example, a middle-school level reader may have content at a high-school level scrolled at the reader's default scrolling rate, while content at a college-level may be scrolled at a suitably slower rate than the reader's default scrolling rate.

In one embodiment, the HMD modifies the web-based resource based on real objects and/or virtual objects within the display region of the HMD. For example, the HMD can use head and eye tracking to determine when a user's point of view of content from a web-based resource is in some way obstructed by an object. The HMD can analyze the web-based resource and make modifications to content and/or elements of the resource based on the object and the gaze information of the user. The system can modify DIV tags for example, to reflow content around objects. The system can also modify DIV tags or other elements to cause content to be placed on the object without portions of the content extending beyond the object's dimensions. The system can also modify CSS elements, for example, to change colors, transparency, etc. to improve the reading experience.

In one embodiment, the HMD generates statistics as a user views specific content displayed by the HMD. The statistics can be collected from multiple users to generate telemetry data for content that can be provided to an originator of the content. The statistics can include time to read portions or the entirety of an article. The statistics may also track a location in a document a user reads more slowly or more quickly. Other statistics may include a location in a document where a user stopped reading the article, or locations where a user read the content more than once.

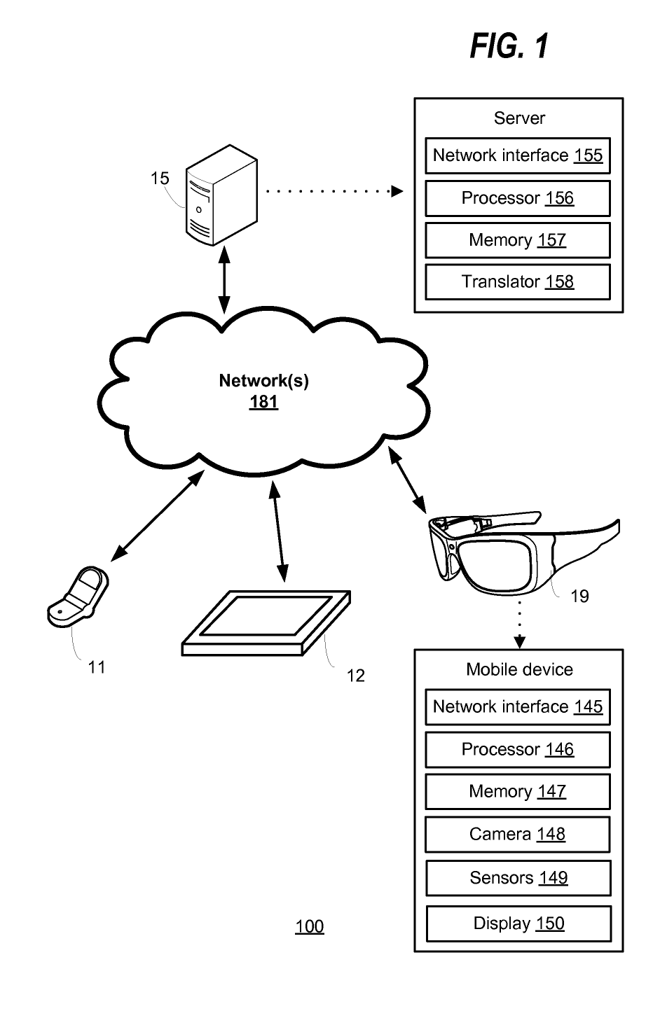

FIG. 1 is a block diagram of one embodiment of a networked computing environment 100 in which the disclosed technology may be practiced. Networked computing environment 100 includes a plurality of computing devices interconnected through one or more networks 181. The one or more networks 181 allow a particular computing device to connect to and communicate with another computing device. The depicted computing devices include mobile device 11, mobile device 12, mobile device 19, and server 15. In some embodiments, the plurality of computing devices may include other computing devices not shown. In some embodiments, the plurality of computing devices may include more than or less than the number of computing devices shown in FIG. 1. The one or more networks 181 may include a secure network such as an enterprise private network, an unsecure network such as a wireless open network, a local area network (LAN), a wide area network (WAN), and the Internet. Each network of the one or more networks 181 may include hubs, bridges, routers, switches, and wired transmission media such as a wired network or direct-wired connection.

Server 15, which may comprise a supplemental information server or an application server, may allow a client to download information (e.g., text, audio, image, and video files) from the server or to perform a search query related to particular information stored on the server. In general, a “server” may include a hardware device that acts as the host in a client-server relationship or a software process that shares a resource with or performs work for one or more clients. Communication between computing devices in a client-server relationship may be initiated by a client sending a request to the server asking for access to a particular resource or for particular work to be performed. The server may subsequently perform the actions requested and send a response back to the client.

One embodiment of server 15 includes a network interface 155, processor 156, memory 157, and translator 158, all in communication with each other. Network interface 155 allows server 15 to connect to one or more networks 181. Network interface 155 may include a wireless network interface, a modem, and/or a wired network interface. Processor 156 allows server 15 to execute computer readable instructions stored in memory 157 in order to perform processes discussed herein. Translator 158 may include mapping logic for translating a first file of a first file format into a corresponding second file of a second file format (i.e., the second file may be a translated version of the first file). Translator 158 may be configured using file mapping instructions that provide instructions for mapping files of a first file format (or portions thereof) into corresponding files of a second file format.

One embodiment of mobile device 19 includes a network interface 145, processor 146, memory 147, camera 148, sensors 149, and display 150, all in communication with each other. Network interface 145 allows mobile device 19 to connect to one or more networks 181. Network interface 145 may include a wireless network interface, a modem, and/or a wired network interface. Processor 146 allows mobile device 19 to execute computer readable instructions stored in memory 147 in order to perform processes discussed herein. Camera 148 may capture color images and/or depth images of an environment. The mobile device 19 may include outward facing cameras that capture images of the environment and inward facing cameras that capture images of the end user of the mobile device. Sensors 149 may generate motion and/or orientation information associated with mobile device 19. In some cases, sensors 149 may comprise an inertial measurement unit (IMU). Display 150 may display digital images and/or videos. Display 150 may comprise a see-through display.

In some embodiments, various components of mobile device 19 including the network interface 145, processor 146, memory 147, camera 148, and sensors 149 may be integrated on a single chip substrate. In one example, the network interface 145, processor 146, memory 147, camera 148, and sensors 149 may be integrated as a system on a chip (SOC). In other embodiments, the network interface 145, processor 146, memory 147, camera 148, and sensors 149 may be integrated within a single package.

In some embodiments, mobile device 19 may provide a natural user interface (NUI) by employing camera 148, sensors 149, and gesture recognition software running on processor 146. With a natural user interface, a person's body parts and movements may be detected, interpreted, and used to control various aspects of a computing application. In one example, a computing device utilizing a natural user interface may infer the intent of a person interacting with the computing device (e.g., that the end user has performed a particular gesture in order to control the computing device).

Networked computing environment 100 may provide a cloud computing environment for one or more computing devices. Cloud computing refers to Internet-based computing, wherein shared resources, software, and/or information are provided to one or more computing devices on-demand via the Internet (or other global network). The term “cloud” is used as a metaphor for the Internet, based on the cloud drawings used in computer networking diagrams to depict the Internet as an abstraction of the underlying infrastructure it represents.

In one example, mobile device 19 comprises a head-mounted display device (HMD) that provides an augmented reality environment or a mixed reality environment to an end user of the HMD. The HMD may comprise a video see-through and/or an optical see-through system. An optical see-through HMD worn by an end user may allow actual direct viewing of a real-world environment (e.g., via transparent lenses) and may, at the same time, project images of a virtual object into the visual field of the end user thereby augmenting the real-world environment perceived by the end user with the virtual object.

Utilizing an HMD, an end user may move around a real-world environment (e.g., a living room) wearing the HMD and perceive views of the real-world overlaid with images of virtual objects. The virtual objects may appear to maintain coherent spatial relationship with the real-world environment (i.e., as the end user turns their head or moves within the real-world environment, the images displayed to the end user will change such that the virtual objects appear to exist within the real-world environment as perceived by the end user). The virtual objects may also appear fixed with respect to the end user's point of view (e.g., a virtual menu that always appears in the top right corner of the end user's point of view regardless of how the end user turns their head or moves within the real-world environment). In one embodiment, environmental mapping of the real-world environment may be performed by server 15 (i.e., on the server side) while camera localization may be performed on mobile device 19 (i.e., on the client side). The virtual objects may include a text description associated with a real-world object.

In some embodiments, a mobile device, such as mobile device 19, may be in communication with a server in the cloud, such as server 15, and may provide to the server location information (e.g., the location of the mobile device via GPS coordinates) and/or image information (e.g., information regarding objects detected within a field of view of the mobile device) associated with the mobile device. In response, the server may transmit to the mobile device one or more virtual objects based upon the location information and/or image information provided to the server. In one embodiment, the mobile device 19 may specify a particular file format for receiving the one or more virtual objects and server 15 may transmit to the mobile device 19 the one or more virtual objects embodied within a file of the particular file format.

In some embodiments, a mobile device, such as mobile device 19, may comprise an HMD that provides an augmented reality environment including a virtual content reader. The virtual content reader may comprise a virtual object within the augmented reality environment in which content may be read by an end user of the HMD. In one embodiment, the virtual content reader may comprise a virtual object that appears fixed with respect to the end user's point of view (i.e., a head-locked virtual object). For example, the virtual content reader may appear in the top left corner of the end user's point of view regardless of how the end user turns their head. In another embodiment, the virtual content reader may comprise a virtual object that appears to maintain a coherent spatial relationship within the augmented reality environment (i.e., a world-locked virtual object). For example, as the end user turns their head or moves within the augmented reality environment, the images displayed to the end user on the HMD will change such that the virtual content reader appears to exist within the augmented reality environment at a particular location (e.g., on a wall).

In one embodiment, an HMD may determine an ambient lighting condition within an augmented reality environment and may adjust a font size and/or a contrast coloring for content displayed on a virtual content reader. The adjustments to the font size and/or the contrast coloring may depend on both the ambient lighting condition and a perceived distance of the virtual content reader from the end user of the HMD. In some cases, if the end user is in a dark environment (e.g., outside at night), then the font size may be increased if the virtual content reader is more than 2 meters away. In another example, if the end user is in a bright environment (e.g., outside on a sunny day), then instead of displaying black text on a white background, the virtual content reader may display the content using blue text overlaying an orange background if the virtual content reader is more than 2 feet away.

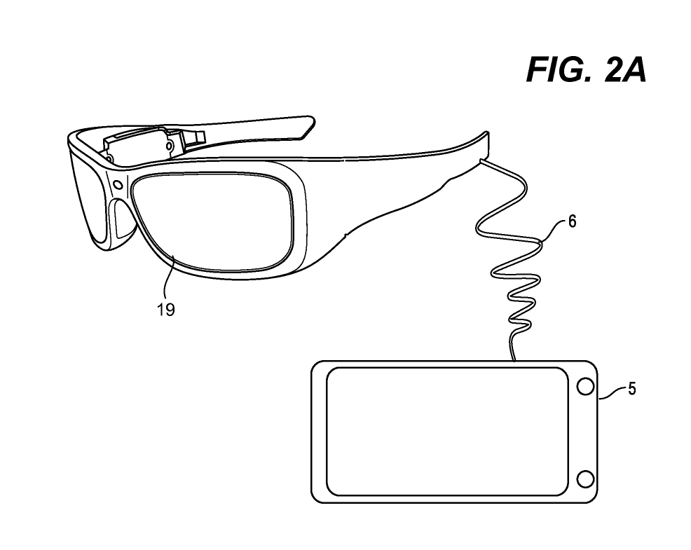

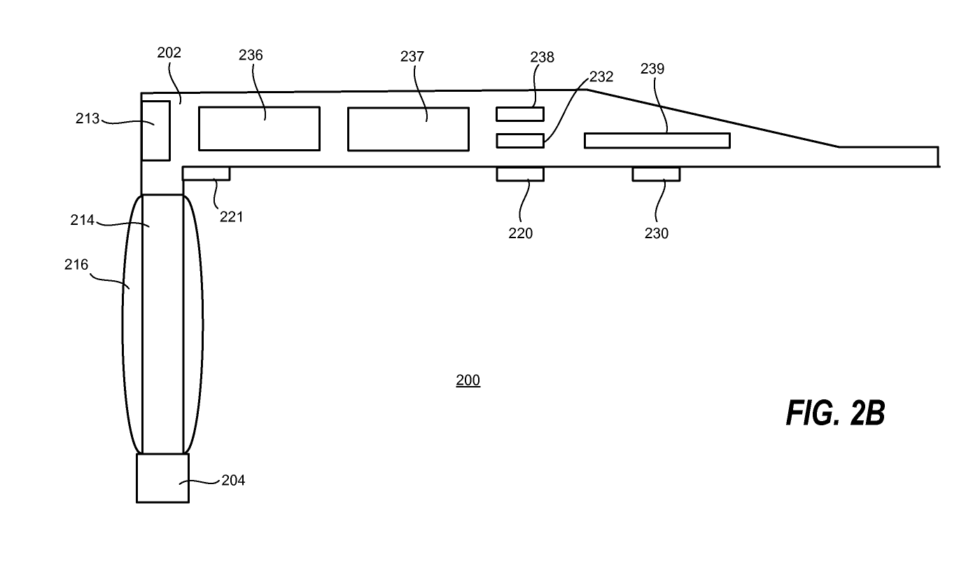

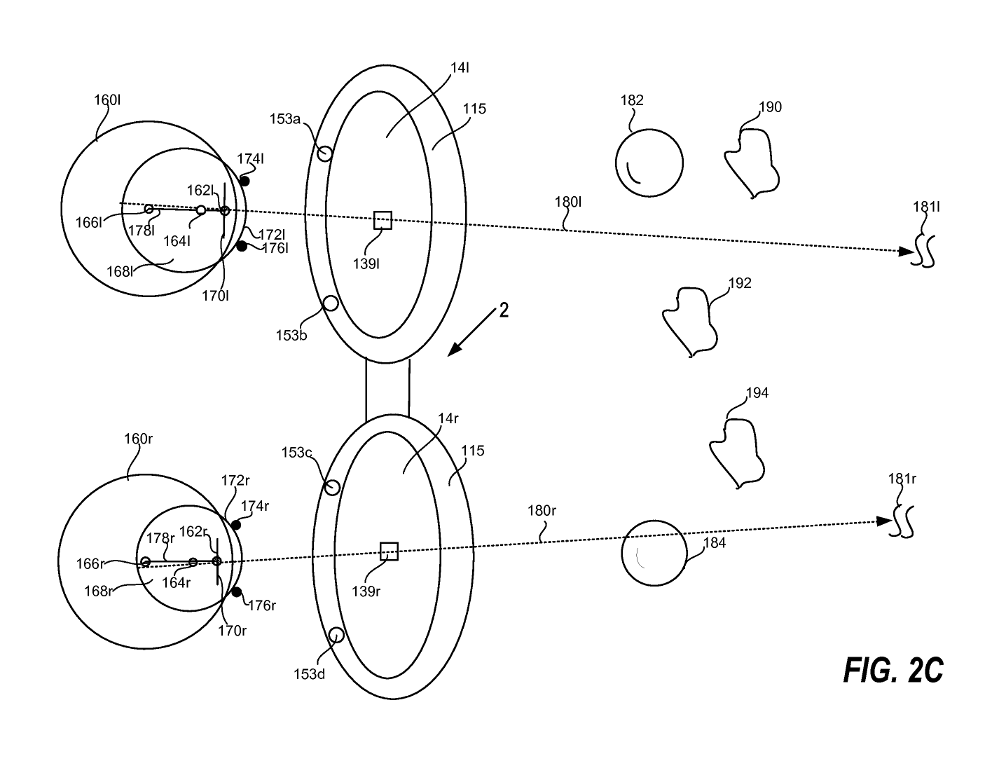

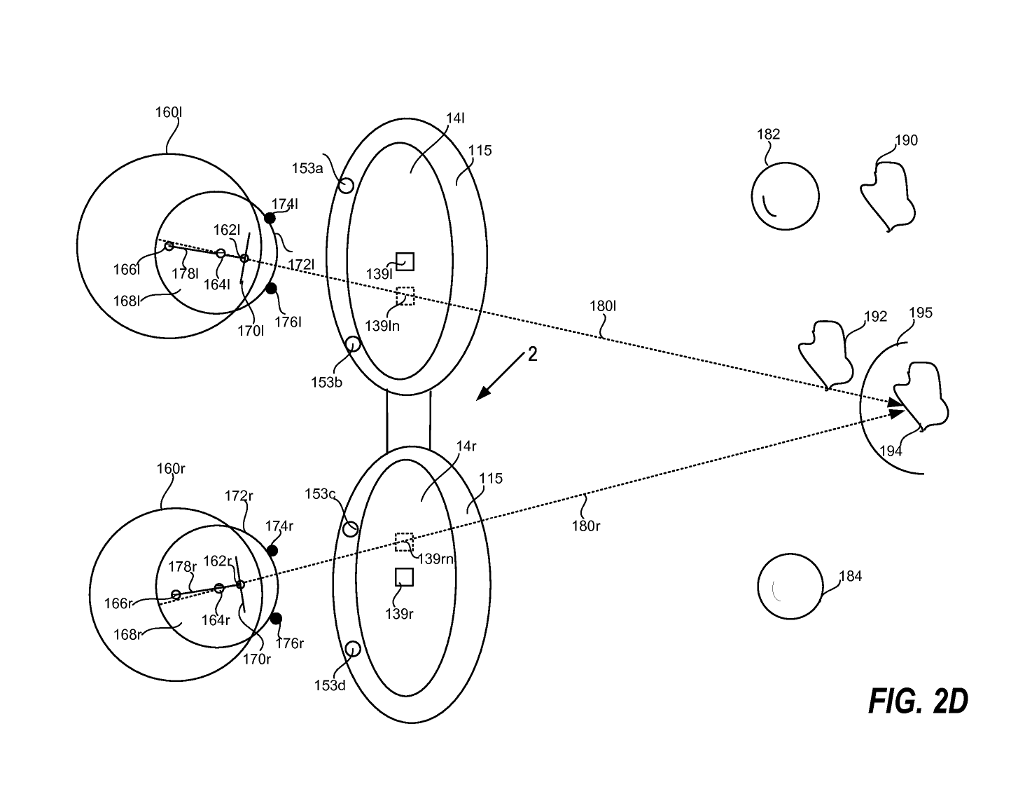

FIG. 2A depicts one embodiment of a mobile device 19 in communication with a second mobile device 5. Mobile device 19 may comprise an HMD including a see-through display. As depicted, mobile device 19 communicates with mobile device 5 via a wired connection 6. However, the mobile device 19 may also communicate with mobile device 5 via a wireless connection. Mobile device 5 may be used by mobile device 19 in order to offload compute intensive processing tasks (e.g., the rendering of virtual objects) and to store virtual object information and other data that may be used to provide an augmented reality environment on mobile device 19. Mobile device 5 may also provide motion and/or orientation information associated with mobile device 5 to mobile device 19. In one example, the motion information may include a velocity or acceleration associated with the mobile device 5 and the orientation information may include Euler angles, which provide rotational information around a particular coordinate system or frame of reference. In some cases, mobile device 5 may include a motion and orientation sensor, such as an inertial measurement unit (IMU), in order to acquire motion and/or orientation information associated with mobile device 5.

FIG. 2B depicts one embodiment of a portion of an HMD, such as mobile device 19 in FIG. 1. Only the right side of an HMD 200 is depicted. HMD 200 includes right temple 202, nose bridge 204, eye glass 216, and eye glass frame 214. Right temple 202 includes a capture device 213 (e.g., a front facing camera and/or microphone) in communication with processing unit 236. The capture device 213 may include one or more cameras for recording digital images and/or videos and may transmit the visual recordings to processing unit 236. The one or more cameras may capture color information, IR information, and/or depth information. The capture device 213 may also include one or more microphones for recording sounds and may transmit the audio recordings to processing unit 236.

Right temple 202 also includes biometric sensor 220, eye tracking system 221, ear phones 230, motion and orientation sensor 238, GPS receiver 232, power supply 239, and wireless interface 237, all in communication with processing unit 236. Biometric sensor 220 may include one or more electrodes for determining a pulse or heart rate associated with an end user of HMD 200 and a temperature sensor for determining a body temperature associated with the end user of HMD 200. In one embodiment, biometric sensor 220 includes a pulse rate measuring sensor which presses against the temple of the end user. Motion and orientation sensor 238 may include a three axis magnetometer, a three axis gyro, and/or a three axis accelerometer. In one embodiment, the motion and orientation sensor 238 may comprise an inertial measurement unit (IMU). The GPS receiver may determine a GPS location associated with HMD 200. Processing unit 236 may include one or more processors and a memory for storing computer readable instructions to be executed on the one or more processors. The memory may also store other types of data to be executed on the one or more processors.

In one embodiment, the eye tracking system 221 may include one or more inward facing cameras. In another embodiment, the eye tracking system 221 may comprise an eye tracking illumination source and an associated eye tracking image sensor. In one embodiment, the eye tracking illumination source may include one or more infrared (IR) emitters such as an infrared light emitting diode (LED) or a laser (e.g. VCSEL) emitting about a predetermined IR wavelength or a range of wavelengths. In some embodiments, the eye tracking sensor may include an IR camera or an IR position sensitive detector (PSD) for tracking glint positions. More information about eye tracking systems can be found in U.S. Pat. No. 7,401,920, entitled “Head Mounted Eye Tracking and Display System”, issued Jul. 22, 2008, and U.S. patent application Ser. No. 13/245,700, entitled “Integrated Eye Tracking and Display System,” filed Sep. 26, 2011, both of which are herein incorporated by reference.

In one embodiment, eye glass 216 may comprise a see-through display, whereby images generated by processing unit 236 may be projected and/or displayed on the see-through display. The capture device 213 may be calibrated such that a field of view captured by the capture device 213 corresponds with the field of view as seen by an end user of HMD 200. The ear phones 230 may be used to output sounds associated with the projected images of virtual objects. In some embodiments, HMD 200 may include two or more front facing cameras (e.g., one on each temple) in order to obtain depth from stereo information associated with the field of view captured by the front facing cameras. The two or more front facing cameras may also comprise 3D, IR, and/or RGB cameras. Depth information may also be acquired from a single camera utilizing depth from motion techniques. For example, two images may be acquired from the single camera associated with two different points in space at different points in time. Parallax calculations may then be performed given position information regarding the two different points in space.

In some embodiments, HMD 200 may perform gaze detection for each eye of an end user's eyes using gaze detection elements and a three-dimensional coordinate system in relation to one or more human eye elements such as a cornea center, a center of eyeball rotation, or a pupil center. Gaze detection may be used to identify where the end user is focusing within a field of view. Examples of gaze detection elements may include glint generating illuminators and sensors for capturing data representing the generated glints. In some cases, the center of the cornea can be determined based on two glints using planar geometry. The center of the cornea links the pupil center and the center of rotation of the eyeball, which may be treated as a fixed location for determining an optical axis of the end user's eye at a certain gaze or viewing angle.

FIG. 2C depicts one embodiment of a portion of an HMD 2 in which gaze vectors extending to a point of gaze are used for aligning a far inter-pupillary distance (IPD). HMD 2 is one example of a mobile device, such as mobile device 19 in FIG. 1. As depicted, gaze vectors 180l and 180r intersect at a point of gaze that is far away from the end user (i.e., the gaze vectors 180l and 180r do not intersect as the end user is looking at an object far away). A model of the eyeball for eyeballs 160l and 160r is illustrated for each eye based on the Gullstrand schematic eye model. Each eyeball is modeled as a sphere with a center of rotation 166 and includes a cornea 168 modeled as a sphere having a center 164. The cornea 168 rotates with the eyeball, and the center of rotation 166 of the eyeball may be treated as a fixed point. The cornea 168 covers an iris 170 with a pupil 162 at its center. On the surface 172 of each cornea are glints 174 and 176.

As depicted in FIG. 2C, a sensor detection area 139 (i.e., 139l and 139r, respectively) is aligned with the optical axis of each display optical system 14 within an eyeglass frame 115. In one example, the sensor associated with the detection area may include one or more cameras capable of capturing image data representing glints 174l and 176l generated respectively by illuminators 153a and 153b on the left side of the frame 115 and data representing glints 174r and 176r generated respectively by illuminators 153c and 153d on the right side of the frame 115. Through the display optical systems 14l and 14r in the eyeglass frame 115, the end user's field of view includes both real objects 190, 192, and 194 and virtual objects 182 and 184.

The axis 178 formed from the center of rotation 166 through the cornea center 164 to the pupil 162 comprises the optical axis of the eye. A gaze vector 180 may also be referred to as the line of sight or visual axis which extends from the fovea through the center of the pupil 162. In some embodiments, the optical axis is determined and a small correction is determined through user calibration to obtain the visual axis which is selected as the gaze vector. For each end user, a virtual object may be displayed by the display device at each of a number of predetermined positions at different horizontal and vertical positions. An optical axis may be computed for each eye during display of the object at each position, and a ray modeled as extending from the position into the user's eye. A gaze offset angle with horizontal and vertical components may be determined based on how the optical axis must be moved to align with the modeled ray. From the different positions, an average gaze offset angle with horizontal or vertical components can be selected as the small correction to be applied to each computed optical axis. In some embodiments, only a horizontal component is used for the gaze offset angle correction.

As depicted in FIG. 2C, the gaze vectors 180l and 180r are not perfectly parallel as the vectors become closer together as they extend from the eyeball into the field of view at a point of gaze. At each display optical system 14, the gaze vector 180 appears to intersect the optical axis upon which the sensor detection area 139 is centered. In this configuration, the optical axes are aligned with the inter-pupillary distance (IPD). When an end user is looking straight ahead, the IPD measured is also referred to as the far IPD.

FIG. 2D depicts one embodiment of a portion of an HMD 2 in which gaze vectors extending to a point of gaze are used for aligning a near inter-pupillary distance (IPD). HMD 2 is one example of a mobile device, such as mobile device 19 in FIG. 1. As depicted, the cornea 168l of the left eye is rotated to the right or towards the end user's nose, and the cornea 168r of the right eye is rotated to the left or towards the end user's nose. Both pupils are gazing at a real object 194 within a particular distance of the end user. Gaze vectors 180l and 180r from each eye enter the Panum's fusional region 195 in which real object 194 is located. The Panum's fusional region is the area of single vision in a binocular viewing system like that of human vision. The intersection of the gaze vectors 180l and 180r indicates that the end user is looking at real object 194. At such a distance, as the eyeballs rotate inward, the distance between their pupils decreases to a near IPD. The near IPD is typically about 4 mm less than the far IPD. A near IPD distance criteria (e.g., a point of gaze at less than four feet from the end user) may be used to switch or adjust the IPD alignment of the display optical systems 14 to that of the near IPD. For the near IPD, each display optical system 14 may be moved toward the end user's nose so the optical axis, and detection area 139, moves toward the nose a few millimeters as represented by detection areas 139ln and 139rn.

More information about determining the IPD for an end user of an HMD and adjusting the display optical systems accordingly can be found in U.S. patent application Ser. No. 13/250,878, entitled “Personal Audio/Visual System,” filed Sep. 30, 2011, which is herein incorporated by reference in its entirety.

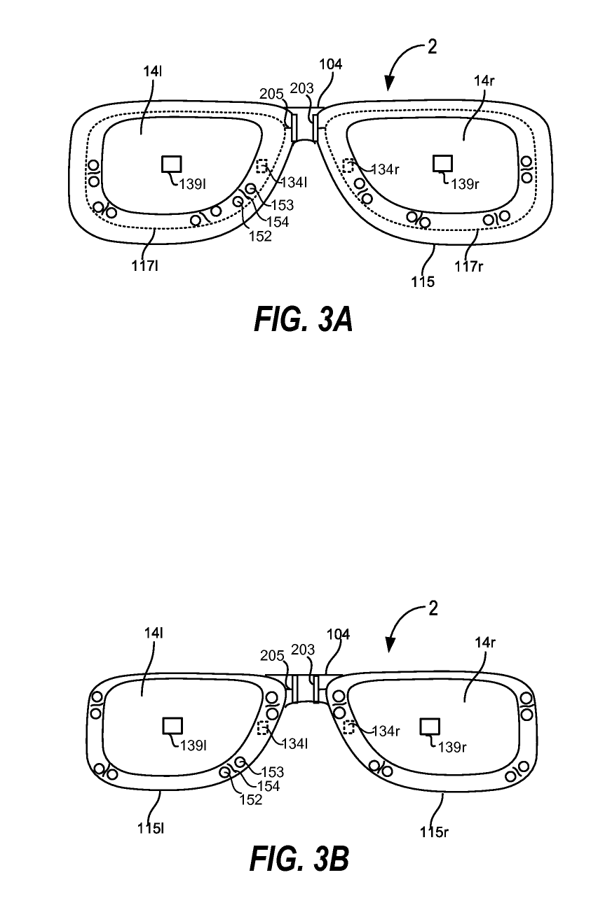

FIG. 3A depicts one embodiment of a portion of an HMD 2 with movable display optical systems including gaze detection elements. What appears as a lens for each eye represents a display optical system 14 for each eye (i.e., 14l and 14r). A display optical system includes a see-through lens and optical elements (e.g. mirrors, filters) for seamlessly fusing virtual content with the actual direct real world view seen through the lenses of the HMD. A display optical system 14 has an optical axis which is generally in the center of the see-through lens in which light is generally collimated to provide a distortionless view. For example, when an eye care professional fits an ordinary pair of eyeglasses to an end user's face, the glasses are usually fit such that they sit on the end user's nose at a position where each pupil is aligned with the center or optical axis of the respective lens resulting in generally collimated light reaching the end user's eye for a clear or distortionless view.

As depicted in FIG. 3A, a detection area 139r, 139l of at least one sensor is aligned with the optical axis of its respective display optical system 14r, 14l so that the center of the detection area 139r, 139l is capturing light along the optical axis. If the display optical system 14 is aligned with the end user's pupil, then each detection area 139 of the respective sensor 134 is aligned with the end user's pupil. Reflected light of the detection area 139 is transferred via one or more optical elements to the actual image sensor 134 of the camera, which in the embodiment depicted is illustrated by the dashed line as being inside the frame 115. In some embodiments, the sensor 134 may comprise an image sensor or RGB camera for capturing images of an end user's eyes or facial features surrounding the eyes. Other inward facing image sensors may also be integrated with the frame 115 in order to capture fixed facial features associated with the end user such as their nasal bridge.

In one embodiment, the at least one sensor 134 may be a visible light camera (e.g., an RGB or color camera). In one example, an optical element or light directing element comprises a visible light reflecting mirror which is partially transmissive and partially reflective. The visible light camera provides image data of the pupil of the end user's eye, while IR photodetectors 152 capture glints which are reflections in the IR portion of the spectrum. If a visible light camera is used, reflections of virtual images may appear in the eye data captured by the camera. An image filtering technique may be used to remove the virtual image reflections if desired. An IR camera may not be sensitive to the virtual image reflections on the eye.

In another embodiment, the at least one sensor 134 (i.e., 134l and 134r) is an IR camera or a position sensitive detector (PSD) to which the IR radiation may be directed. The IR radiation reflected from the eye may be from incident radiation of the illuminators 153, other IR illuminators (not shown), or from ambient IR radiation reflected off the eye. In some cases, sensor 134 may be a combination of an RGB and an IR camera, and the light directing elements may include a visible light reflecting or diverting element and an IR radiation reflecting or diverting element. In some cases, the sensor 134 may be embedded within a lens of the system 14. Additionally, an image filtering technique may be applied to blend the camera into a user field of view to lessen any distraction to the user.

As depicted in FIG. 3A, there are four sets of an illuminator 153 paired with a photodetector 152 and separated by a barrier 154 to avoid interference between the incident light generated by the illuminator 153 and the reflected light received at the photodetector 152. To avoid unnecessary clutter in the drawings, drawing numerals are shown with respect to a representative pair. Each illuminator may be an infra-red (IR) illuminator which generates a narrow beam of light at about a predetermined wavelength. Each of the photodetectors may be selected to capture light at about the predetermined wavelength Infra-red may also include near-infrared. As there can be wavelength drift of an illuminator or photodetector or a small range about a wavelength may be acceptable, the illuminator and photodetector may have a tolerance range about a wavelength for generation and detection. In some embodiments where the sensor is an IR camera or IR position sensitive detector (PSD), the photodetectors may include additional data capture devices and may also be used to monitor the operation of the illuminators, e.g. wavelength drift, beam width changes, etc. The photodetectors may also provide glint data with a visible light camera as the sensor 134.

As depicted in FIG. 3A, each display optical system 14 and its arrangement of gaze detection elements facing each eye (e.g., such as camera sensor 134 and its detection area 139, the illuminators 153, and photodetectors 152) are located on a movable inner frame portion 117l, 117r. In this example, a display adjustment mechanism comprises one or more motors 203 having a shaft 205 which attaches to the inner frame portion 117 which slides from left to right or vice versa within the frame 115 under the guidance and power of shafts 205 driven by motors 203. In some embodiments, one motor 203 may drive both inner frames.

FIG. 3B depicts an alternative embodiment of a portion of an HMD 2 with movable display optical systems including gaze detection elements. As depicted, each display optical system 14 is enclosed in a separate frame portion 115l, 115r. Each of the frame portions may be moved separately by the motors 203. In some embodiments, the at least one sensor 134 may comprise an image sensor or RGB camera for capturing images of an end user's eyes or facial features surrounding the eyes. Other inward facing image sensors may be integrated with the frame 115 in order to capture fixed facial features associated with the end user such as their nasal bridge.

In one embodiment, an HMD can determine points of focus within content and corresponding elements from web-based resources that correlate to active view regions within the display. Visual indications of a point of focus can be applied to particular content based on the underlying resource rather than highlighting a region of the display without correlation to the underlying content. In this manner, the highlight or visual indication of a point of focus can highlight text or other pieces of content without spilling over or encroaching on adjacent content. Such content may inadvertently be highlighted if an approach that only examines an actively viewed region of the display is taken alone without correlation to the underlying resource.

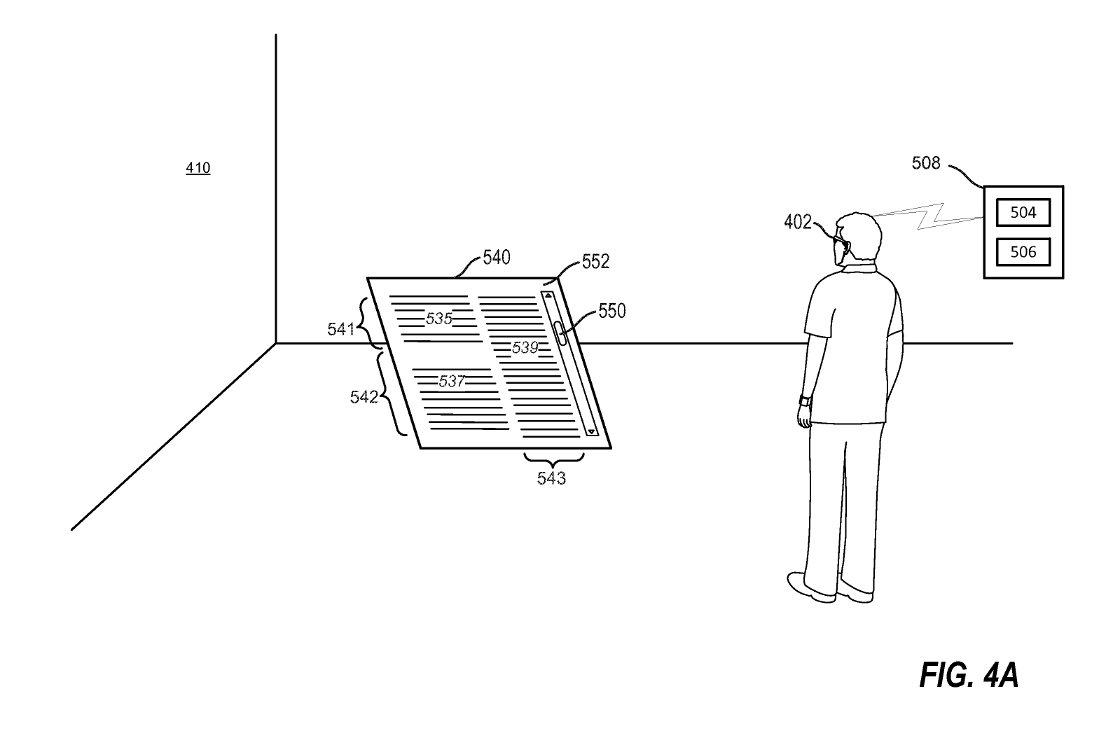

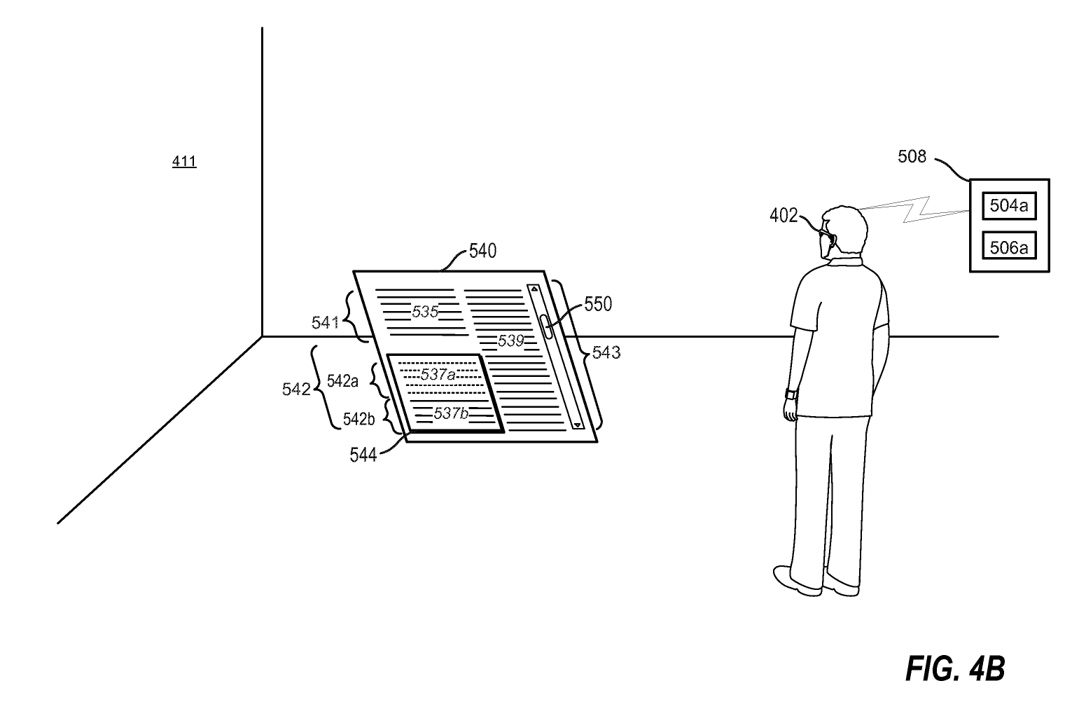

FIG. 4A depicts one embodiment of an HMD 402 worn by an end user viewing a virtual content reader 540 (VCR) within an augmented reality environment 410. The HMD 402 may comprise a mobile device, such as mobile device 19 in FIG. 1. The virtual content reader may include a scrollbar 550 and a display region 552 for displaying content to the end user. A VCR can be any region of the see-through display that displays content to the user such as content from web-based resources. VCR 540 may include multiple display regions, for example to simultaneously display content from multiple web-based resources within the augmented reality environment. The VCR is shown in a view-locked scenario in FIG. 4A. VCR 540 may be world-locked in other examples, appearing to be displayed on a virtual or real-world object such as a wall or table within environment 410.

In this particular example, the display region 552 displays content 504 from web-based resource 508, such as a webpage. Display region 552 includes a first region 541 corresponding to a first portion 535 of the content from web-based resource 508, a second region 542 corresponding to a second portion 537 of the content from the web-based resource, and a third region 543 corresponding to a third portion 539 of the content from the web-based resource. By way of example, the first region may include content from a first article, the second region may include content form a second article, and the third region may include content from a third article. An article may include any viewable division of the content from a web-based resource. For example, different pictures or videos from a webpage may be considered different articles of the webpage. Different articles within a webpage can be identified by parsing a webpage to identify display elements such as DIV tags that divide content within a webpage in one example. In one embodiment, the content to be displayed may be converted from a multiple column format into a single column format before being displayed.

In one embodiment, the HMD utilizes the tracking information including eye and/or head movement data to determine an active view region, if any, within the augmented reality environment provided by the see-through display of the HMD. For example, the HMD can analyze the eye gaze information and head view direction over time. Based on a sufficient stability of eye and/or head movement within a region of the display, the HMD can determine that the end user is actively viewing a particular region within the display region of the HMD.

FIG. 4B depicts one embodiment of an HMD 402 worn by an end user who is again viewing VCR 540 as it displays content from web-based resource 508 in an augmented reality environment 411. In this example, the HMD has determined that the second region 542 of the VCR including the second portion 537 of the content is an active view region. The HMD analyzes web-based resource 508 from which the content is derived. The HMD can analyze or parse a webpage, for example, to determine its hierarchy, including the various elements and attributes associated with the content of the webpage. The HMD correlates the tracking information including any active view regions with the webpage analysis to identify portions of the web-based resource that correspond to a desired point of focus of the user. This can include determining the content being actively viewed by the end user, as well as the elements of the webpage that are associated with the content. For example, the HMD may determine from the tracking information that the end user is actively viewing a particular region of the display. Based on a webpage analysis, the HMD determines that the region is a particular line of text. From an analysis of the webpage hierarchy, the HMD may further determine that the particular line of text is part of one article or grouping of content within the webpage. In response, the HMD can automatically highlight the particular line of text and/or the article corresponding to the particular line of text.

In FIG. 4B, the HMD has determined that the user is actively viewing or is reading a line of text from content 537b in a lower sub-region 542b of the second region 542 of the display. The HMD can analyze the webpage hierarchy and determine that the line of text is within a portion of the content of the webpage corresponding to a particular article. For example, the HMD may determine a set of DIV tags associated with a block of text including the line being read by the user. Based on identifying the particular article within the webpage, the HMD provides a visual highlight 544 for the second article. In this example, the second region 542 of the display includes a border providing the visual highlight. The HMD can change the web-based resource so that the border is generated. The HMD can modify display elements and/or add display elements and content, for example, to generate an image to provide the border at the second region of the display.

In FIG. 4B, the HMD uses the tracking information to determine that the end user has read the content 537a within the upper sub-region 542a. In response, the HMD provides a visual indication that content 537a has already been read by the user and that content 537b has not been read by the user. For example, the HMD may present content 537a in a first color and content 537b in a second color. The HMD may change a color or provide another indication that a user has read particular portions of the displayed content, such as words, sentences, or paragraphs or has viewed images, watched videos, etc. The HMD can automatically scroll the content within the active view region. While the content is automatically scrolled, the color or other indication of the previously read portions of the displayed content can be changed as the end user reads portions of the displayed content.

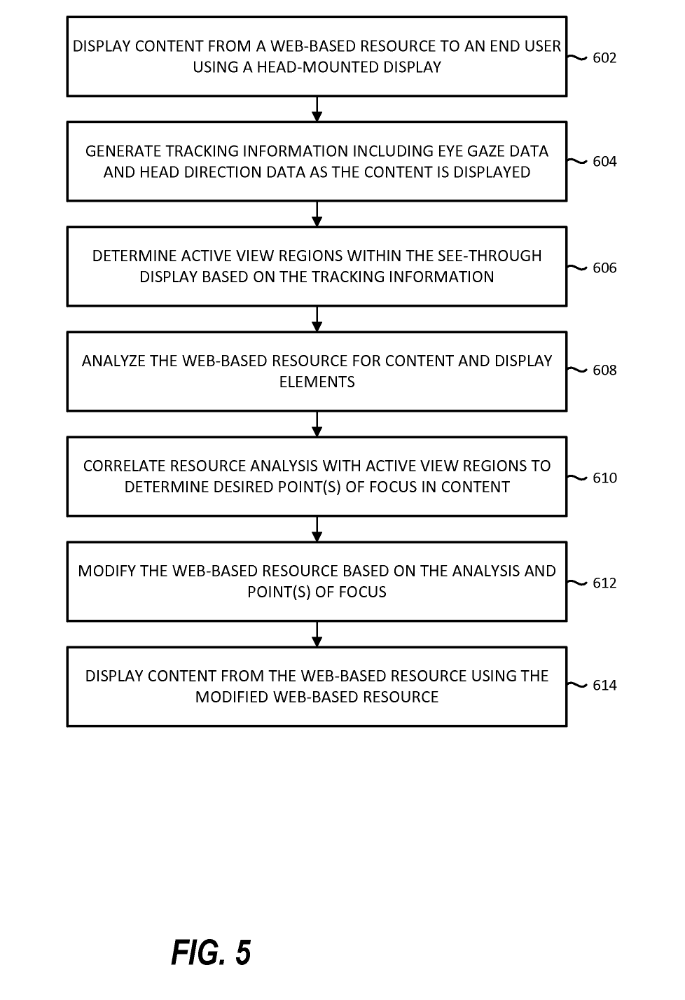

FIG. 5 is a flowchart describing a method of displaying content using an HMD in accordance with one embodiment. The process of FIG. 5 may be performed by a mobile device, such as mobile device 19 in FIG. 1 in one embodiment. By way of example, the process in FIG. 5 may be used by mobile device 19 to generate VCR 540 as shown in FIGS. 4A-4B.

At step 602, the HMD displays content from a web-based resource to an end user wearing the HMD. The content can include text, symbols, images, and/or video by way of example. In one example, the content may comprise text associated with a web-based resource such as an electronic book, an electronic magazine, a word processing document, a webpage, or an email. At step 604, the HMD generates tracking information including eye gaze data and head direction data as the end user views the displayed content.

At step 606, the HMD determines any active view regions within the see-through display of the HMD based on the tracking information. Step 606 may include using a time threshold to determine if the user is actively viewing or is otherwise engaged with a particular region of the display. For example, the HMD may consider a region an active region after the tracking information indicates a user's gaze within the region while keeping a steady head direction for a threshold period of time.

At step 608, the HMD analyzes the web-based resource from which the content being displayed is derived. The HMD can parse a webpage for example, to determine the content and various display elements of the webpage such as HTML elements and CSS elements. The analysis enables the HMD to parse a webpage into a collection of articles or other divisions of content within the webpage. In this manner, the HMD is able to determine the underlying structure and presentation format for the content in the resource. The HMD may also analyze the content to determine article content information such as the subject matter of an article, the level of complexity of an article or portions of an article, keywords in the article, the title of an article, etc. In this manner, the HMD can perform both a structural analysis of the web-based resource and a semantic analysis of the content in the web-based resource.

At step 610, the HMD correlates the resource analysis from step 608 with the active region determined at step 606 to determine any desired points of focus in the content. Step 610 facilitates an understanding of any focus of the user within the content that is being displayed. The HMD is able to determine not only an area of focus within the display, but an area of focus within the content that is being displayed. The HMD can compare the structure of the web-based resource to determine the actual content that corresponds to the user's view. For instance, the HMD may determine a line of text or word within an article that the user is viewing at any given moment. By moving from the display region of focus to the content of focus, the HMD can more granularly and precisely determine what is being viewed. Step 610 may include using the structure of the resource, such as DIV tags and the like, to determine the boundaries of the article within which the user's view is currently situated. In this manner, the HMD may determine from a point of focus, which line of content is being read, and from the line being read, the larger article within which the line appears.

Step 610 may further include using the content analysis of the content corresponding to the active view region to determine any desired points of focus. For example, the HMD may determine that the user is viewing a line of text in an article. The HMD may analyze the content of the line of text or of the entire article within which the line appears. The HMD may adjust a threshold period of time used to determine a point of focus based on the complexity of the text for example. Similarly, the HMD may use different threshold periods for determining that images are a point of focus than that text is a point of focus.

General reading statistics for a large group of users may be used to determine the appropriate amount of time before considering a portion of content as a point of focus. In this manner, the HMD can minimize false positives in determining a point of focus with the content being displayed. This can be useful to distinguish cases where a player is quickly reading and simply scrolls down vertically from cases where the user isn't actually reading. The system may use different time thresholds based on a semantic analysis of the content from the underlying web-based resource.

It is noted that while steps 606-610 are shown as discreet steps, they may be performed together and repetitively to determine areas of the content in a web-based resource that are a point of focus. For example, the HMD may analyze the resource first, then determine any active regions of the display and corresponding points of focus based on the analysis of the resource.

At step 612, the HMD modifies a portion of the web-based resource based on any points of focus determined at step 610. Step 612 may include highlighting text of the content that is the user's point of focus. The HMD may add a visual highlight to an article when it is determined that the user's point of focus is within a line of the article, for example. The visual highlight can include a border around the article for example. In another example, the visual highlight may further include visual highlights within the article content to aid the user's reading of the content. Step 612 may include modifying the content or various display elements within a webpage. For example, the HMD may modify HTML elements or CSS elements to change a background color for the article corresponding to the point of focus. Any number and type of changes to the web-based resource may be performed at step 612. The HMD may also remove or add content and/or resource elements from a web-based resource as part of step 612. For example, content and elements for the content may be used to create a visual highlight for an article. Similarly, the HMD may remove content and elements such as JavaScript or other system resource intensive elements of a resource when they are not a point of focus.

At step 614, the HMD displays content from the web-based resource based on the modified portion of the web-based resource from step 612. For example, the HMD may display any updated content, remove any removed content from the display, or alter the display of content based on changes to the resource elements.

The HMD may also modify web-based resources to reorganize content within the web-based resource based on a user's content preferences. The HMD may utilize a user profile containing the content preferences of the user to determine how to display and therefore modify a web-based resource. The content preferences of the user are based on eye gaze information generated for the user as they are viewing content in one embodiment. By examining the content of web-based resources that a user views or interacts with more frequently, the HMD determines content preferences for the user. The user may also explicitly provide content preference information to the HMD, through a visual or other interface configured to receive such information. The HMD can analyze a web-based resource to determine article content information for the articles or other divisions of content within a resource. The HMD compares the article content information with the user's content preference information to determine how to display the content from the web-based resource. For example, the HMD may prioritize articles based on their correlation with the content preferences of the user. Articles with higher correlations to content preference information may be prioritized higher than articles with lower correlations to content preference information. The HMD can modify the web-based resource to provide a visual indication to the end user of this prioritization. For example, a visual highlight such as a border can be added to articles that more closely correlate to the user's content preferences. The arrangement or ordering of articles on the display may be modified based on the prioritization.

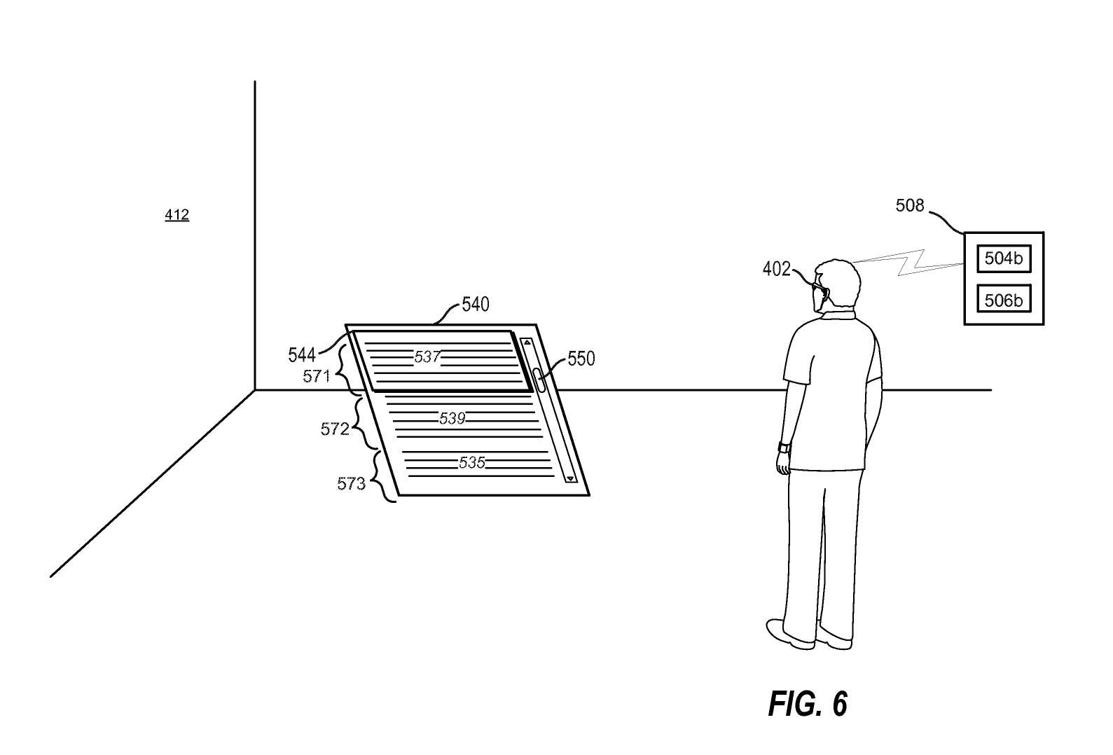

FIG. 6 depicts one embodiment of an HMD 402 worn by an end user viewing a virtual content reader 540 within an augmented reality environment 412. In FIG. 6, the end user is again viewing content from a web-based resource 508. In this example, the HMD analyzes the web-based resource 508 prior to display on the virtual content reader. Based on the analysis and user content preference information, the HMD modifies the content 504 and/or the resource elements 506 of the resource 508, generating modified content 504b and/or modified display elements 506b.

In this example, the HMD analyzes the content 504 and display elements 506 from resource 508. The HMD determines that the first portion 535 of the content corresponds to a first article, the second portion 537 of the content corresponds to a second article, and the third portion 539 corresponds to a third article. The HMD performs a semantic analysis to generate article content information for each article. This article content information provides a semantic analysis of the content of the resource. The HMD compares the previously generated content preferences of the user to determine a correlation between the user's content preferences and the article content information. In this example, the HMD determines that the second portion 537 of the content has the strongest correlation to the user's content preferences. The HMD determines that the first portion 535 of the content has the weakest correlation to the user's content preferences. The HMD determines that the third portion 539 of the content has a correlation with the user's content preferences that is between that of the second portion and the first portion.

Based on the correlations, the HMD modifies the web-based resource to generate modified content 504b and/or modified resource elements 506b. In this example, the HMD generates modified resource elements 506b that re-order the content so that the second portion 537 of the content is displayed in an upper region 571 of VCR 540, content 539 is displayed in a middle region 572, and the first portion 535 of the content is displayed in a lower region 573. In this manner, the HMD reorders the articles to align with the user's content preferences. Additionally, the HMD generates modified content 504b and/or elements 506b to generate a visual highlight 544 around the second portion 537 of the content in region 551. It is noted that any type of modification to the display elements or content can be made. For example, the HMD may center the second portion 537 of the content, while providing the third portion of the content 539 and the first portion 535 of the content above and below the second portion 537 of the content.

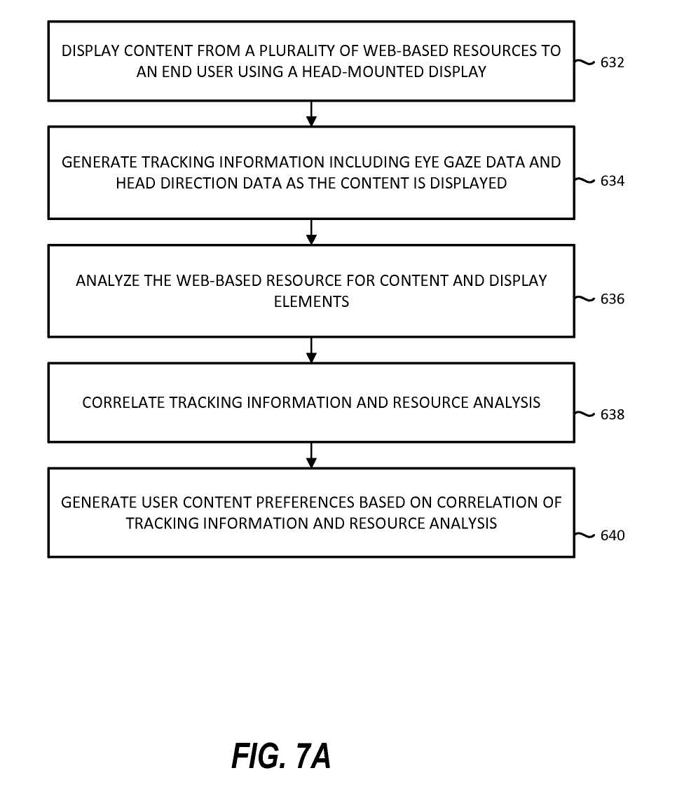

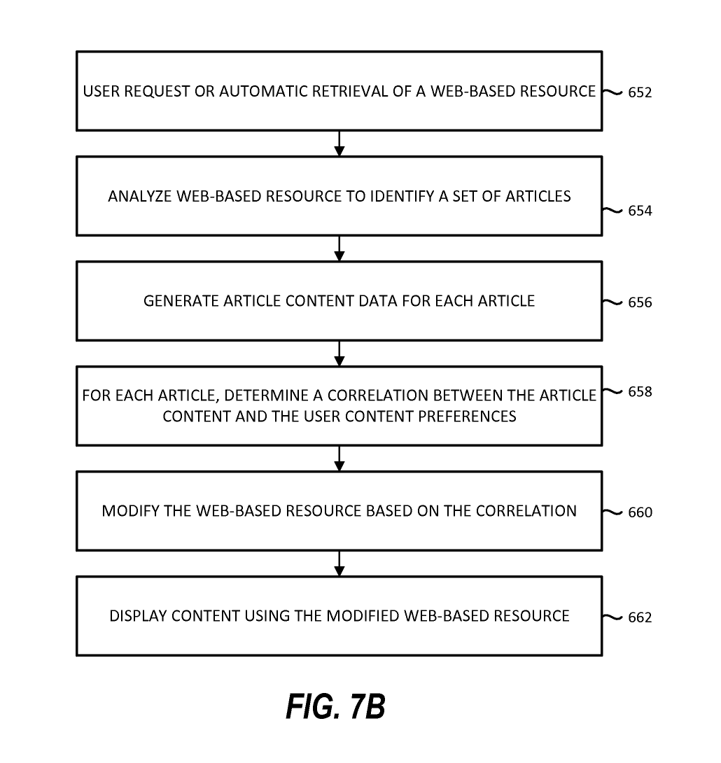

FIG. 7A is a flowchart describing one embodiment of a method for displaying content using an HMD. FIG. 7A describes one example of generating user content preference information based on tracking information.

At step 632, the HMD displays content from a plurality of web-based resources to an end user using the HMD. As the user views the content from the plurality of web-based resources, the HMD generates tracking information including eye gaze data and head direction data at step 634. At step 636, the HMD analyzes each web-based resource to determine its structure and content. For example, the HMD may parse web pages to determine their display elements and corresponding content. Within the content, the HMD may perform a semantic or subject-matter based analysis to generate article content information that characterizes the content of the individual articles or other division of content with the resource.

At step 638, the HMD correlates the tracking information with the analysis of the web-based resource. While viewing a particular web-based resource, the HMD may determine which content such as an article from a group of article the user views. The HMD can more granularly determine within individual articles subject matter that a user views. For example, the HMD may first determine that a user reads an article having sports as its base subject matter based on a content analysis. The HMD may further determine that within the sports article, the user read or read more closely read subject matter relating to a particular sport or sports team.

At step 640, the HMD generates user content preferences based on the correlation of the tracking information and the resource analysis. The HMD can examine the correlation of the eye tracking information over the plurality of resources to determine subject matter, persons, images, videos, or other types of interests or preferences of the user. By examining the user's behavior based on eye tracking when viewing many different web-based resources, the HMD is able to determine types of content that the user prefers.

FIG. 7B is a flowchart describing a process of displaying content using an HMD based on user content preferences. The process in FIG. 7B may be performed using the user content preferences from FIG. 7A in one example. At step 652, the HMD acquires a web-based resource. In one example, the HMD acquires the web-based resource in response to an explicit user request. In another example, the HMD may automatically retrieve a web-based resource. The HMD can automatically retrieve resources based on the user's content preferences for example.

At step 654, the HMD analyzes the web-based resource to identify a set of articles. The HMD can parse a webpage, for example, to determine the display element structure and content of the webpage. In this manner, the HMD can parse a webpage including multiple divisions of content such as articles into individual articles for prioritization or other manipulation.

At step 656, the HMD generates article content data for the webpage. The HMD can perform a subject matter or semantic analysis of the content within each article to provide summary, identification, or other information relating to the content.

At step 658, the HMD compares the article content data of each article in the web page with the user's content preferences. The HMD can determine a correlation between the content of each article and the user's content preferences at step 658. The correlation characterizes the relatedness between the user's content preferences and the actual content in each article.

At step 660, the HMD modifies the web-based resource based on the correlation of performed in step 658. The HMD can modify content or display elements of the web-based resource using the correlation of the user preferences with the article content. The HMD can modify the web-based resource by changing existing content and/or elements or by adding/removing content and elements for the resource. The HMD can rank each article within a webpage based on the correlation of the content preferences with the article content. The articles can be prioritized for presentation based on the rankings. The articles having a stronger correlation to the user's content preferences can be prioritized for display to the user.

Step 660 may also include generating a visual highlight for any articles that are determined to match or correlate with the user's content preferences. Moreover, step 660 may include generating a status notification including a count of how many articles within a webpage have been determined to match a user's content preferences. The status notification may be visually depicted in the display and automatically updated as the user reads the content. For example, the status notification may indicate the total number of articles determined to match a user's content preferences. The tracking information can be used to determine when a user completes (or begins) reading one of the articles. The visual notification can be decreased by one to indicate the remaining number of prioritized articles left to read.

At step 662, the HMD displays content based on the modified web-based resource. For example, the HMD can display a re-prioritized list of the articles in a webpage with visual highlighting of articles determined to match the user's content preferences.

The HMD may also prioritize links or references in a web-based resource to other resources. For example, the HMD may prioritize and rearrange hyperlinks within a web-based resource based on the user's content preferences. The prioritization and rearrangement can be based on a content analysis of the hyperlinks and/or based on the content of the resources to which the hyperlinks point.

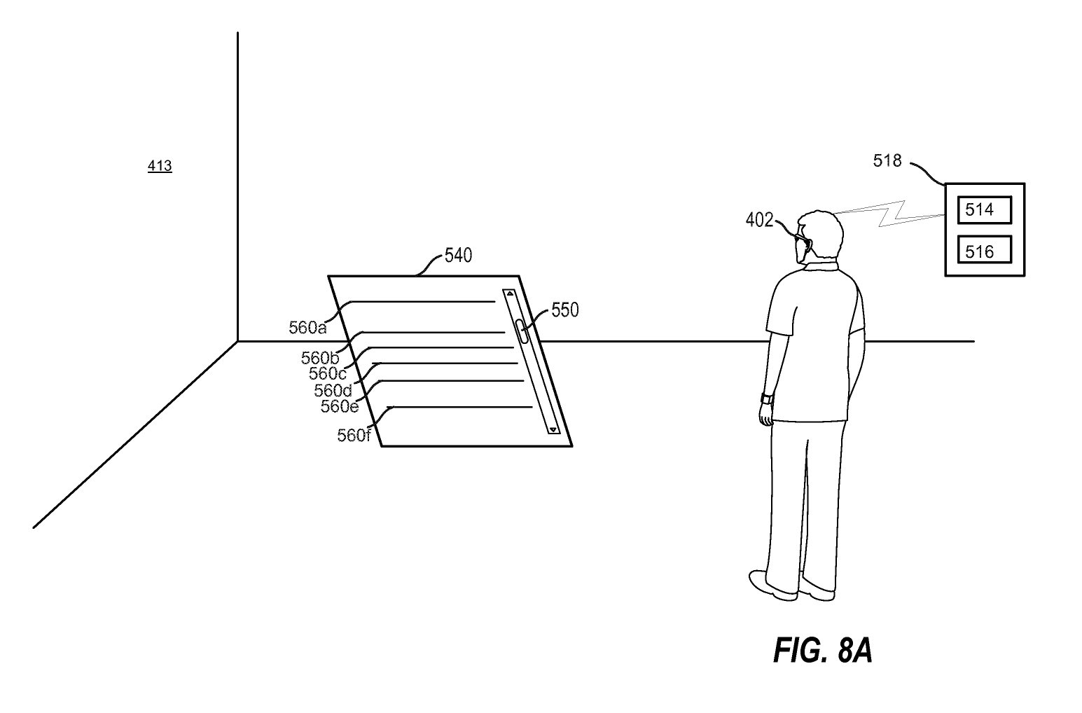

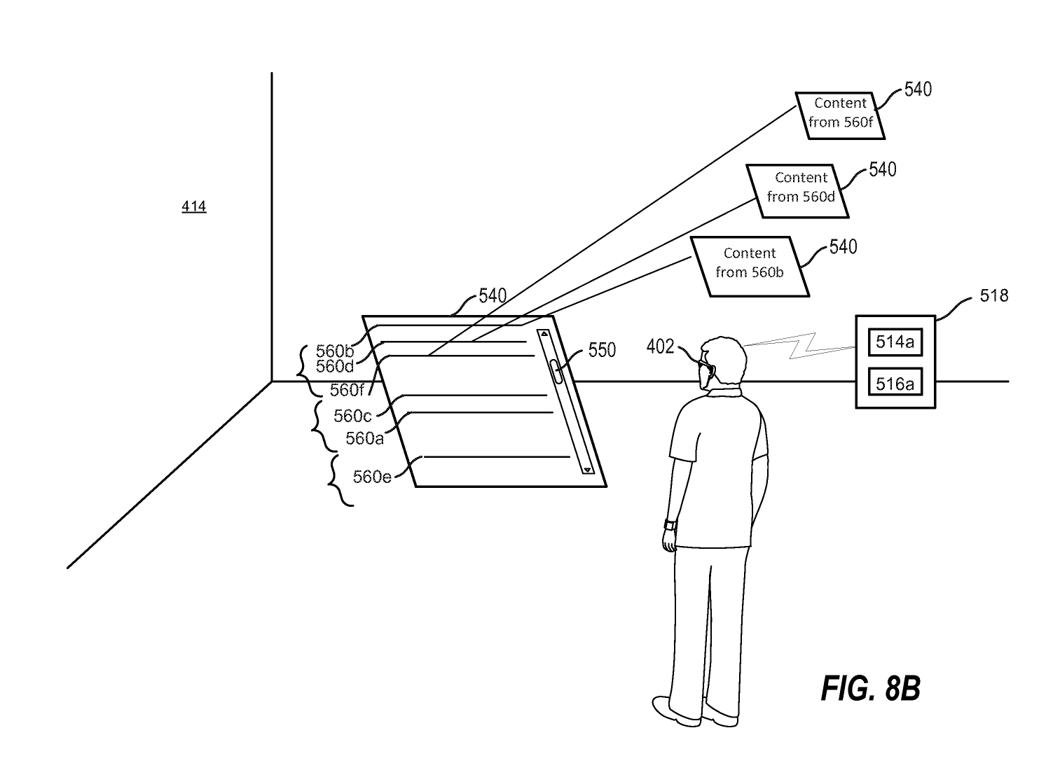

FIG. 8A depicts one embodiment of an HMD 402 worn by an end user viewing a virtual content reader 540 within an augmented reality environment 413. The HMD may comprise a mobile device, such as mobile device 19 in FIG. 1. The virtual content reader 540 includes a scrollbar 550 and a display region for displaying content to the end user. In this example, the VCR 540 is displaying content from a web-based resource 518. The web-based resource includes content 514 and various resource elements 516 such as HTML and CSS elements defining the structure and presentation of the content 514. The content 514 of web-based resource 518 includes a plurality of hyperlinks 560a-560f that are displayed by the VCR 540. Based on the resource elements 516 of resource 518, the links are listed from top to bottom on the VCR from 560a to 560f. FIG. 8A depicts a representation of web-based resource 518 without analysis or application of user content preferences.

FIG. 8B depicts one embodiment of an HMD 402 worn by an end user viewing a virtual content reader 540 within an augmented reality environment 414. The VCR 540 includes a display region which is again displaying content 514 from web-based resource 518. In FIG. 8B, the display of the content has been modified based on the user's content preferences. In this example, the HMD correlates an analysis of the hyperlinks from resource 518 with the user's content preferences. The HMD determines that the content referred to by hyperlink 560b is most likely to be of interest to the user. The HMD determines that the content referred to by hyperlink 560d is the next likely to be of interest to the user, that 560f is the next likely, 560c is the next likely, 560a is the next likely, and hyperlink 560e is the least likely to be of interest to the user. In one example, the HMD analyzes resource 518 to identify content 514. The HMD can perform a semantic analysis of the content to determine article content information. In this example, the HMD can analyze each hyperlink to determine article content information for the hyperlink. The article content information can be based on the hyperlink itself, or by retrieving the content referred to by the hyperlink. The HMD compares the article content information for each hyperlink to the user's content preferences to determine a correlation between each article and the user's preferences.

Based on this correlation, the HMD prioritizes the links in an order 560b, 560d, 560f, 560c, 560a, 560e. The HMD then modifies the content 514 and/or the resource elements 516 of web-based resource 518 based on the prioritization to generate modified content 514a and/or modified elements 516b. As with the earlier embodiments, the HMD can change existing content and/or elements, add content and/or elements, or remove content and/or elements to generate the modified content 514a and elements 516a. Based on the modified content 514a and/or elements 516a, VCR 540 displays the hyperlinks in a top to bottom order of 560b, 560d, 560f, 560c, 560a, 560e based on their correspondence or correlation with the user's content preferences. It is noted the hyperlinks may be prioritized in other ways. For example, the order may remain the same but the HMD may alter a size or color of the hyperlinks to create a visual priority for the end user. In one embodiment, the HMD categorizes the sections of a webpage by their links, for example, by visually grouping them into a smaller set of groups named after specific topics.

FIG. 8B also illustrates the HMD pre-fetching a subset of the web-based resources referred to by the hyperlinks in web-based resource 518 based on user content preferences. For example, the HMD can determine that hyperlinks 560b, 560d, and 560f refer to resources with content having a high correlation with the content preferences of the user. Based on the correlation meeting a threshold limit for example, the HMD automatically retrieves the web-based resources referred to by the hyperlinks (based on the URI of the hyperlink). Additionally, the HMD automatically displays a portion of the content from each hyperlink within the augmented reality environment. In this example, each hyperlink refers to a webpage. The HMD can expand virtual content reader 540 to display all or a portion of the content from the web-based resources. In this example, the HMD displays the additional content in the peripheral vision of the user. The content from link 560b is depicted closest to the user, at a smallest depth of view. The content from link 560d is depicted next closest to the user, at an intermediate depth of view. The content from link 560f is depicted furthest from the user, at a largest depth of view. Various techniques may be used to present these resources with dimension or position to indicate their likelihood to match a user's content preferences. In one example, the content from the pre-fetched resources may be presented in a world-locked view. For example, the additional portions of the VCR 540 may be presented as if placed on a wall within environment 414.

In one embodiment, content from web-based resources is reflowed or repositioned within an augmented reality environment to aid in viewing the content. For example, a web-based resource can be modified to reposition content in desired locations within an augmented reality environment. An analysis of a web-based resource can be used to modify the web-based resource to optimize the display of content relative to real-world objects and/or virtual objects in an augmented reality environment.

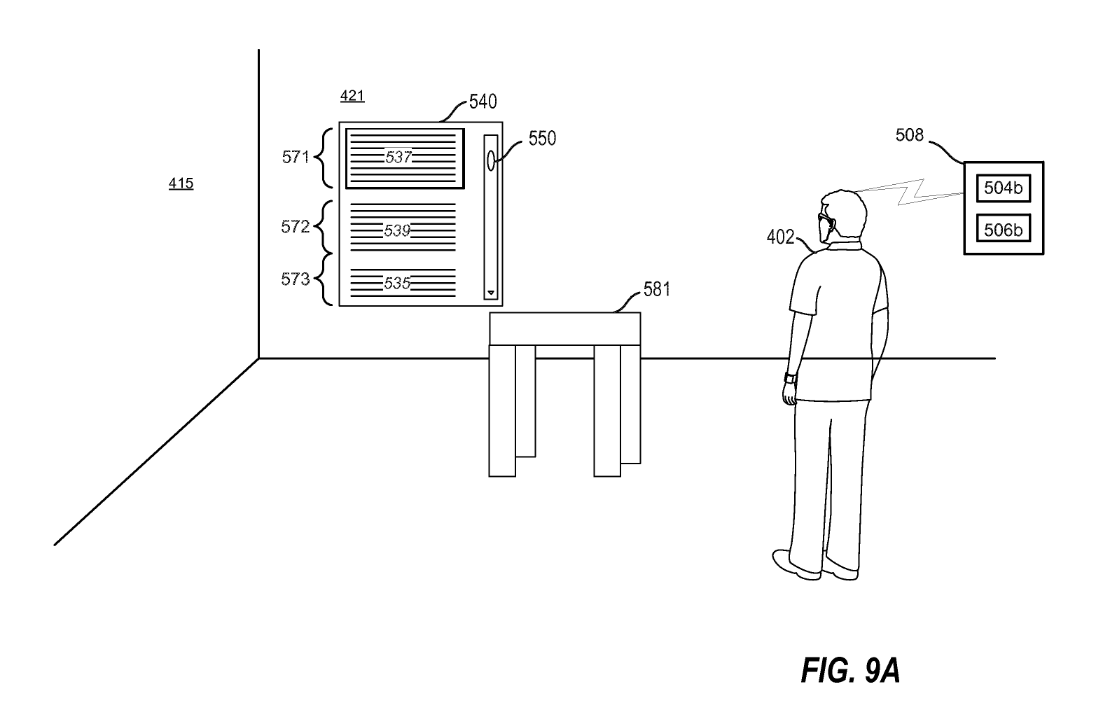

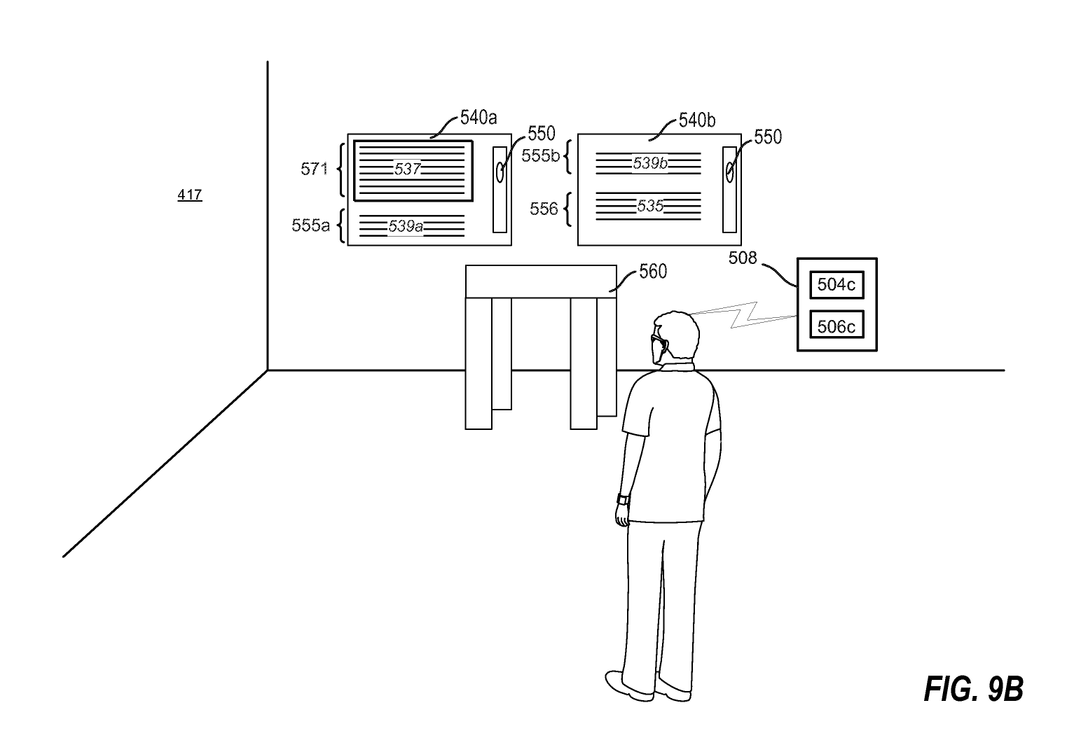

FIG. 9A depicts one embodiment of an HMD 402 worn by an end user viewing a virtual content reader 540 within an augmented reality environment 415. The HMD 402 may comprise a mobile device, such as mobile device 19 in FIG. 1. The VCR 540 displays content 504b from web-based resource 508. Content 504b corresponds with the modified content 504b from FIG. 6 based on the correlation of user content preferences and article content analysis.

In FIG. 9A, VCR 540 is world-locked within the augmented reality environment, appearing to be placed on wall 421. An object 581 (e.g., table) appears in the augmented reality environment. Object 581 may be a real-world object or a virtual object.

HMD 402 determines from image data and the tracking information that object 581 does not obstruct the user's view of the content displayed on VCR 540 with the augmented reality environment 415. Accordingly, the HMD displays the second portion 537 of the content at the upper region of the display, content 539 at the middle region of the display, and the first portion 535 of the content at the lower region of the display. The content is displayed similarly as in FIG. 6, in world-locked view relative to wall 421.

FIG. 9B depicts one embodiment of the HMD 402 worn by the end user viewing the virtual content reader 540 within an augmented reality environment. In FIG. 9B, user 402 has repositioned their body, head direction and/or eye gaze within the augmented reality environment 417, relative to their position and view with the augmented reality environment 416 in FIG. 9A. HMD 402 uses the tracking information and image data to determine that object 581 will obstruct the user's view of the content displayed on VCR 540. HMD 402 accesses the analysis of web-based resource 508 to determine the structure of the content being displayed relative to the user's view and position. HMD 402 can modify resource elements 506b and/or content 504b of resource 508 to reposition or reflow the content for improved display to the user. Thus, HMD 402 can generate modified content 504c and/or modified elements 506c as shown in FIG. 9B.

HMD 402 modifies VCR 540 to include a first portion 540a and a second portion 540b. The second portion 537 of the content remains within the first region 571 of the first portion 540a of the VCR 540. Content 539, however, is split into a first portion 539a that appears at a lower region 555a of the first portion 540a of VCR 540 and a second portion 539b that is displayed in an upper region 555b of the second portion 540b of VCR 540. The second portion 537 of the content is displayed at a lower region 556 of the second portion 540b of VCR 540.

In one embodiment, HMD 402 can modify or generate additional display elements such as DIV elements in HTML or various CSS elements in CSS documents to reposition or reflow content from a web-based resource. In one embodiment, HMD 402 can modify or generate additional content to reposition or reflow content from a web-based resource within the VCR.

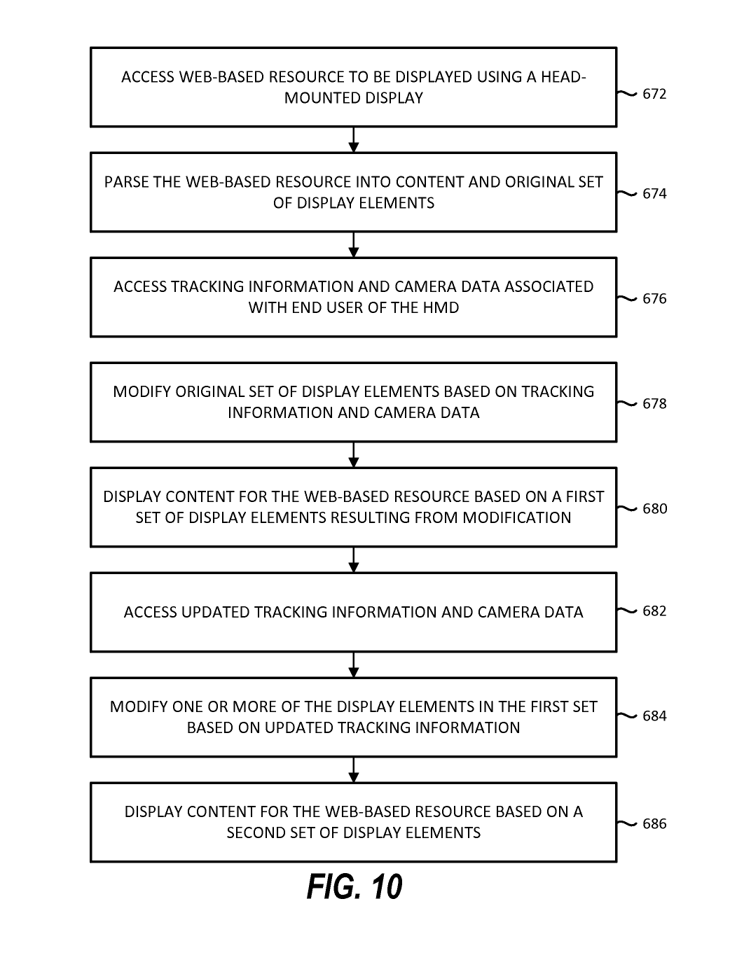

FIG. 10 is a flowchart describing a process of displaying content using an HMD in accordance with one embodiment. The process in FIG. 10 includes repositioning or reflowing content from a web-based resource based on tracking information and camera data associated with a user viewing the content while wearing the HMD.

At step 672, the HMD acquires a web-based resource to be displayed using a head-mounted display. The HMD may acquire a webpage including CSS files, HTML files, etc. At step 674, the HMD parses the resource into its content and an original set of display elements such as HTML elements, CSS elements, etc. associated with the presentation of the content. At step 676, the HMD access current tracking information and camera data associated with the end user of the HMD. At step 678, the HMD makes any initial modifications to the original set of display elements based on the current tracking information and augmented reality environment data. For example, the HMD can modify, add, or delete display elements to modify the content for initial display in the augmented reality environment. The HMD can generate a first set of display elements based on the modifications to the original set of display elements. The first set of display elements may be the same as the original set of display elements. At step 680, the HMD displays the content from the web-based resource based on the first set of display elements.

At step 682, the HMD accesses updated tracking information and camera data. For example, the end user may alter their eye gaze, head position, or body position within the augmented reality environment. At step 684, the HMD modifies one or more of the display elements in the first set of display elements based on the updated tracking information and camera data. For example, the HMD can modify, add, or delete display elements to reposition or reflow content based on objects, either virtual or real, within the augmented reality environment. As earlier described, the HMD may modify display elements to reflow content around objects that obstruct the view of the content from the web-based resource. By modifying the first set of display elements, the HMD generates a second set of display elements at step 684. At step 686, the HMD displays the content from the web-based resource using the second set of display elements.

In one embodiment, the HMD can automatically or optionally reflow the content of web-based resources around both virtual and real world context. For example the HMD may automatically substitute CSS elements for a better reading experience based on real and virtual environments. This may include using black for transparency and/or color swapping based on real world objects (e.g., walls, furniture). The HMD may also automatically scale down javascript to optimize for power. The HMD may also intelligently lay out additional content such as pop-ups, tabs and other additional content based on real world and virtual environments.

In one embodiment, the HMD uses hierarchical information about a web-based resource, which may include links to and from other resources in a hierarchical format, to show relevant information or highlight more relevant information out of a user's current field of view. The HMD may use positional sound data to provide visual and/or auditory highlights. In one example, position sound is used through a head relative transfer function to signal a location of relevant content and the relevance of the additional content to the content currently viewed. For example, the HMD provide a light “bing” or other auditory signal in one example, coming from the upper left (or other location) from the user's perspective to indicate additional research available from a website's hierarchy. For example, when viewing content from a first web-based resource such as a currently viewed webpage, the HMD may display content from links on the current webpage to other webpages. The HMD may display the content out of the user's current field of view and provide a first auditory signal to alert the user to the location of the additional content. A “bong” or different auditory signal from the user's lower left (or other location) may be provided for generic search information on the currently read/unread text. For example, the HMD may perform a web-based search using text from the current content that the user has read or has not yet read. The results of the web-based search may be placed out of the user's current field of view and the HMD may provide a second auditory signal to alert the user to the location of the additional content based on the web-based search. An almost-muted audio or other auditory signal may be provided to the user's lower right for a relevant video. For example, the HMD may retrieve a relevant video using a search or based on the current webpage's hierarchy. The HMD may provide a third auditory signal to alert the user to the location of the additional video content. The HMD may correlate positional sound data with content in other manners to provide notifications of relevant content or additional content.

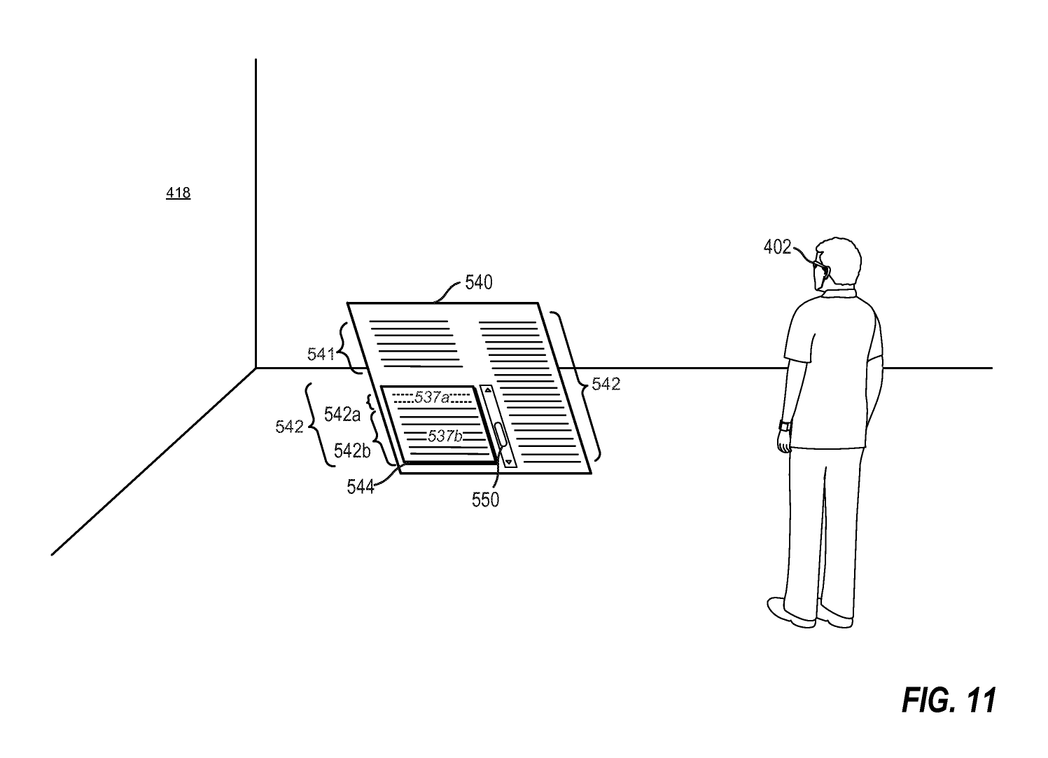

In one embodiment, the HMD may use tracking information with an analysis of a web-based resource to automatically scroll content from web-based resources. FIG. 11 depicts one embodiment of an HMD 402 worn by an end user viewing a virtual content reader 540 within a augmented reality environment 418. The HMD is depicting modified content 504b from web-based resource 508 as depicted in FIG. 4B.

The virtual content reader may include a scrollbar 550 that has scrolled towards the end of the second portion 537 of the content available relative to its location in FIG. 4b. The content 537a that has been read is scrolled toward the upper part of region 542 and additional unread content 537b is scrolled into view. In this example, the scrollbar is associated with the second portion of the content being displayed in the second region 542 of the display. For example, the HMD may associate scrollbar 550 with second region 542 in response to determining that the second portion 537 of content 504 is a point of focus. In other examples, the HMD may provide and associate different scrollbars with different portions of content with the webpage.

The end user may view the second portion 537 of the content as the content is automatically scrolled at a scrolling rate using the VCR 540. The HMD may use the user's head position and view direction stability to determine or estimate whether the user is reading an article, such as the second portion 537 of content 504. The HMD can use the user's history of scrolling with an input device to determine an automatic scrolling speed for the user. For example, the end user may control the scrollbar for scrolling content using the VCR 540. To control the scrollbar, the end user may move their head in an up and down motion for example. In one embodiment, the user may gaze at the scrollbar 550 for a particular period of time (e.g., two seconds) causing a first triggering event in which the end user may control the scrollbar 550. In some cases, once the first triggering event has been detected by the HMD, the scrollbar 550 may be highlighted or a visual indication (e.g., red dot) may appear with the scrollbar and movement of the visual indication may correspond with a head position. Head tracking techniques may be used to determine a head movement speed and a degree of head movement for determining an updated position of the scrollbar. A new position for the scrollbar 550 may be determined based on the head movement speed and the degree of head movement. The new position of the scrollbar 550 may correspond with new content to be displayed on the virtual content reader. To prevent confusion of the automatic scrolling mechanism caused by the end user moving their gaze away from the display region of the virtual content reader 440 for displaying content, automatic content scrolling may be disabled (e.g., automatic scrolling may be stopped) once the first triggering event has been detected. In one embodiment, the automatic content scrolling may be restarted upon detection that the end user has resumed reading content within the display region of the virtual content reader 540. In another embodiment, the automatic content scrolling may be restarted after a time delay has passed (e.g., three seconds) subsequent to the end user moving the scrollbar 550 to the new position.

Based on the user's history of scrolling using the scrollbar 550, for example, the HMD may set an automatic scrolling rate for the end user. The automatic scrolling rate can be updated over time using additional tracking information associated with the end user. Actions such as cancelling an automatic scroll and starting a slower or faster scroll can act as input to determine an automatic scrolling rate for the user.

The HMD may additionally use an analysis of the web-based resource to determine an automatic scrolling rate. The HMD may analyze the content 504 from web-based resource 508 and perform a complexity analysis. The HMD may increase the automatic scrolling rate for content below a baseline level of complexity and may decrease the automatic scrolling rate for content above a baseline level of complexity.

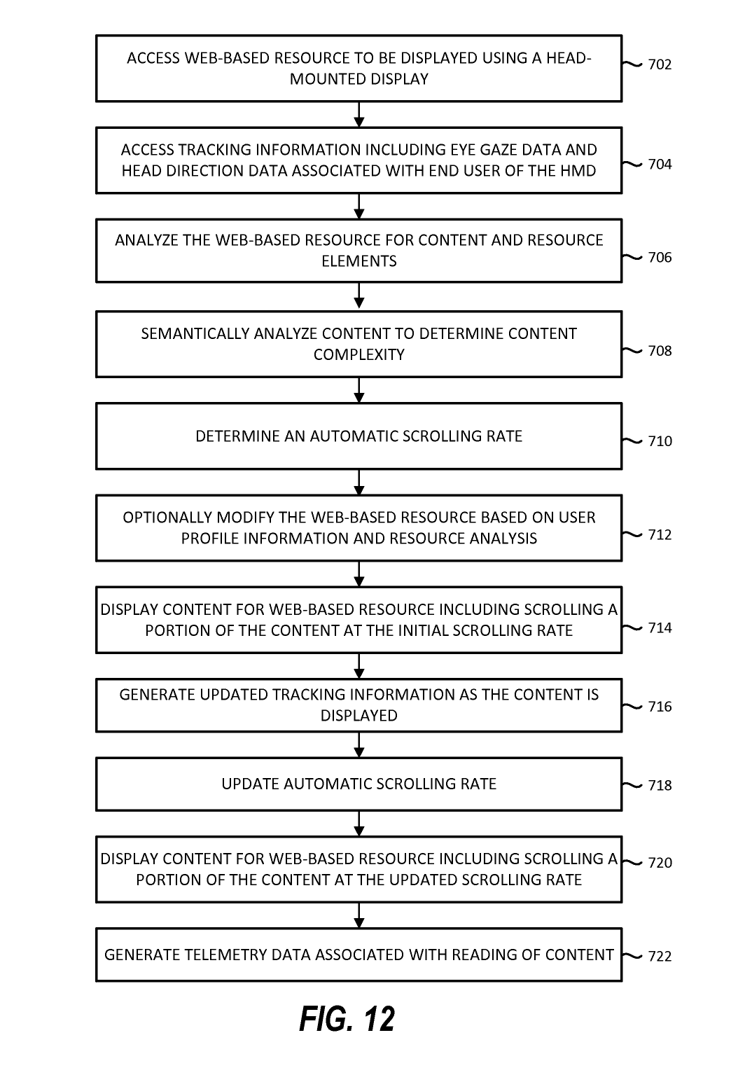

FIG. 12 is a flowchart describing a method of displaying content by an HMD that includes automatically scrolling content based on tracking information associated with a user viewing the content. At step 702, the HMD accesses a web-based resource to be displayed using a head-mounted display worn by an end user. At step 704, the HMD accesses tracking information that includes eye gaze data and head direction data associated with the user of the HMD. At step 706, the HMD analyzes the web-based resource for content and display elements. At step 708, the HMD semantically analyzes the content from the web-based resource to determine a content complexity associated with the content. Step 708 is optional. In one embodiment, step 708 is performed after parsing the web-based resource into its content and display elements. The HMD can perform the semantic analysis on different articles or other divisions of content within the resource.

At step 710, the HMD determines an initial scrolling rate for the content being displayed by the HMD. The initial scrolling rate can be based on user profile information and/or the semantic analysis of the content in one embodiment. For example, the HMD can access the end user's profile to determine an initial scrolling rate associated with the user. The HMD can adjust the initial scrolling rate based on the document complexity. For example, the HMD can increase or decrease the initial scrolling rate by a factor based on the document complexity. For example, the initial scrolling rate can be increased for content below a threshold complexity level and decreased for content above a threshold complexity level based on its difficulty to read. The initial scrolling rate for the end user can be determined from tracking information associated with the user's previous viewing of content on the HMD. The initial scrolling rate for a user can be updated over time.

At step 712, the HMD can optionally modify the web-based resource based on one or more of the user profile information and the analysis of the web-based resource, including the semantic analysis of the resource content. For example, the HMD may highlight content that may be of interest to a user (e.g., FIG. 4B), may rearrange content such as articles to be prioritized in accordance with the user's content preference information (e.g., FIG. 6), or reflow content based on objects in the augmented reality environment (e.g., FIG. 9B).

At step 714, the HMD displays content for the web-based resource. The HMD automatically scrolls at least a portion of a content at the initial scrolling rate calculated at step 710. In one example, the HMD may generate a set of one or more images corresponding with a portion of the content from the web-based resource. The first set of images can be displayed using the see-through display for example. The first set of images may correspond with a virtual content reader within an augmented reality environment such as virtual content reader 540 in FIG. 11. The content may be displayed such that an end user of the see-through display views a portion of the content being read within a first section of the see-through display. The first section may correspond with a region of a virtual content reader, such as the second region 542 in FIG. 11. In one embodiment, the portion of the content being read may correspond with a paragraph being read by the end user. The content displayed on the see-through display is automatically scrolled at the initial scrolling rate. The content displayed on the see-through display may be presented to the end user of the see-through display as being displayed from a virtual content reader within an augmented reality environment, such as virtual content reader 540 in FIG. 11. In some cases, the content displayed within a region of the virtual content reader may be scrolled at the initial scrolling rate. In other cases, the content displayed across all regions of the virtual content reader may be scrolled at the scrolling rate.

In one embodiment, a scrollbar is displayed using the see-through display. The scrollbar may correspond with a second region of the see-through display different from the first region. The second region may be placed adjacent to the first region as shown in FIG. 11 to facilitate scrolling of the content in the second region 542. In another example, a scrollbar may be presented adjacent to all regions as shown in FIG. 6 so that scrolling scrolls all of the content on the virtual content reader.

At step 716, the HMD generates tracking information as the content is displayed. The tracking information can include, in addition to earlier described tracking, information regarding how fast the end user reads the content, where the reader starts and stops reading, and other information regarding user behavior while reading the content.

At step 718, the HMD updates the automatic scrolling rate based on the tracking information and/or event monitoring. The automatic scrolling rate can be updated based on the rate at which the end user is reading the particular content. This can permit the HMD to make subtle adjustments to the scrolling rate in real-time based on the actual content being read, as well as the end-user's personal habits or behavior at a particular moment. The scrolling rate may continuously be updated as the reader reads content to make minor and subtle adjustments to account for changes in the user behavior and changes in the complexity or presentation of the content that may affect reading speed. The HMD may also calculate the scrolling rate based on events detected while the end user reads the content. For example, the HMD may detect that a user stopped scrolling of the content and moved back in a document. This may indicate that the scrolling rate is too fast and the system may adjust the scrolling rate. At step 720, the HMD displays the content at the updated scrolling rate.

At step 722, the HMD optionally generates telemetry data associated with the end-user reading of the content. For example, the HMD can generate information regarding the user's rate of reading the content. The HMD can determine how far the reader read into the content before stopping. If particular sections were read at a rate that was significantly slower or faster than other sections of the content, the HMD can generate information identifying this. The HMD can report the telemetry data back to a server. The server can collect and aggregate the telemetry data for presentation to the originator of the content such as the author. In this manner, the telemetry data can provide actual statistics about reading behavior associated with content.

One embodiment of the disclosed technology includes one or more processors in communication with a see-through display. The see-through display can display a virtual content reader to an end user of an electronic device. The electronic device may include an HMD. The one or more processors display content from a web-based resource to an end user using the see-through display. The one or more processors generate tracking information based on eye movement and head movement of the end user as the end user views the content from the web-based resource. The one or more processors identify an active view region of the see-through display based on the tracking information. The one or more processors analyze the web-based resource for the content and a set of display elements associated with the content. The one or more processors identify a point of focus based on correlating the active view region and analyzing the web-based resource. The one or more processors modify the web-based resource based on identifying the point of focus and use a modified portion of the web-based resource to display the content from the web-based resource to the end user through the see-through display.

One embodiment of the disclosed technology includes displaying content from a plurality of web-based resources to an end user using a see-through display, generating tracking information based on eye movement and head movement of the end user as the end user views the content from the plurality of web-based resources, analyzing the content from the plurality of web-based resources to determine article content information, correlating the article content information from the plurality of web-based resources with the tracking information to generate content preference information for the end user, accessing an additional web-based resource after generating the content preference information, modifying the additional web-based resource based on the content preference information, and displaying content from the additional web-based resource based on a modified portion of the additional web-based resource.

One embodiment of the disclosed technology includes accessing a web-based resource including content, accessing tracking information of an end user indicating a first view relative to an augmented reality environment, displaying the content from the web-based resource based on the first view and a first set of display elements, and accessing additional tracking information of the end user indicating a second view relative to the augmented reality environment. The augmented reality environment includes an object obstructing the second view of the content. The disclosed technology includes generating a second set of display elements based on the additional tracking information to reposition the content relative to the object and displaying the content from the web-based resource based on the second view and the second set of display elements.

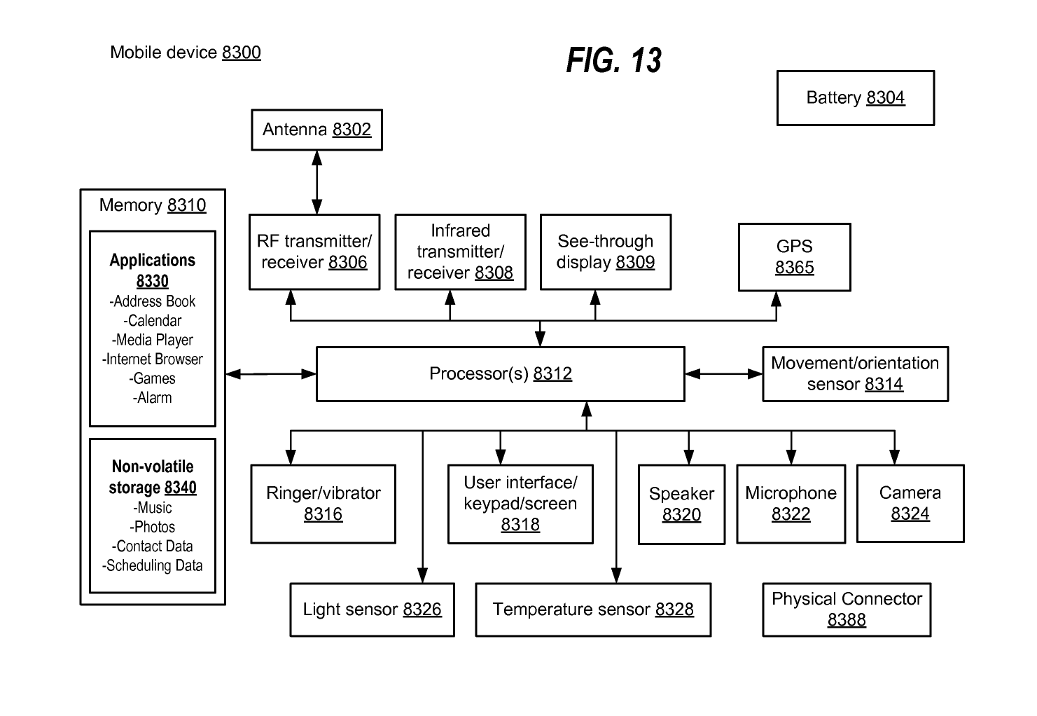

FIG. 13 is a block diagram of one embodiment of a mobile device 8300, such as mobile device 19 in FIG. 1. Mobile devices may include laptop computers, pocket computers, mobile phones, HMDs, personal digital assistants, and handheld media devices that have been integrated with wireless receiver/transmitter technology.

Mobile device 8300 includes one or more processors 8312 and memory 8310. Memory 8310 includes applications 8330 and non-volatile storage 8340. Memory 8310 can be any variety of memory storage media types, including non-volatile and volatile memory. A mobile device operating system handles the different operations of the mobile device 8300 and may contain user interfaces for operations, such as placing and receiving phone calls, text messaging, checking voicemail, and the like. The applications 8330 can be any assortment of programs, such as a camera application for photos and/or videos, an address book, a calendar application, a media player, an internet browser, games, an alarm application, and other applications. The non-volatile storage component 8340 in memory 8310 may contain data such as music, photos, contact data, scheduling data, and other files.

The one or more processors 8312 are in communication with a see-through display 8309. The see-through display 8309 may display one or more virtual objects associated with a real-world environment. The one or more processors 8312 also communicates with RF transmitter/receiver 8306 which in turn is coupled to an antenna 8302, with infrared transmitter/receiver 8308, with global positioning service (GPS) receiver 8365, and with movement/orientation sensor 8314 which may include an accelerometer and/or magnetometer. RF transmitter/receiver 8308 may enable wireless communication via various wireless technology standards such as Bluetooth® or the IEEE 802.11 standards. Accelerometers have been incorporated into mobile devices to enable applications such as intelligent user interface applications that let users input commands through gestures, and orientation applications which can automatically change the display from portrait to landscape when the mobile device is rotated. An accelerometer can be provided, e.g., by a micro-electromechanical system (MEMS) which is a tiny mechanical device (of micrometer dimensions) built onto a semiconductor chip. Acceleration direction, as well as orientation, vibration, and shock can be sensed. The one or more processors 8312 further communicate with a ringer/vibrator 8316, a user interface keypad/screen 8318, a speaker 8320, a microphone 8322, a camera 8324, a light sensor 8326, and a temperature sensor 8328. The user interface keypad/screen may include a touch-sensitive screen display.

The one or more processors 8312 controls transmission and reception of wireless signals. During a transmission mode, the one or more processors 8312 provide voice signals from microphone 8322, or other data signals, to the RF transmitter/receiver 8306. The transmitter/receiver 8306 transmits the signals through the antenna 8302. The ringer/vibrator 8316 is used to signal an incoming call, text message, calendar reminder, alarm clock reminder, or other notification to the user. During a receiving mode, the RF transmitter/receiver 8306 receives a voice signal or data signal from a remote station through the antenna 8302. A received voice signal is provided to the speaker 8320 while other received data signals are processed appropriately.

Additionally, a physical connector 8388 may be used to connect the mobile device 8300 to an external power source, such as an AC adapter or powered docking station, in order to recharge battery 8304. The physical connector 8388 may also be used as a data connection to an external computing device. The data connection allows for operations such as synchronizing mobile device data with the computing data on another device.

The disclosed technology is operational with numerous general purpose or special purpose computing system environments or configurations. Examples of well-known computing systems, environments, and/or configurations that may be suitable for use with the technology include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosed technology may be described in the general context of computer-executable instructions, such as program modules, being executed by a computer. Generally, software and program modules as described herein include routines, programs, objects, components, data structures, and other types of structures that perform particular tasks or implement particular abstract data types. Hardware or combinations of hardware and software may be substituted for software modules as described herein.

One or more embodiments of the present disclosure may include a variety of computer readable media. Computer readable media can be any available media that can be accessed by a computing device and includes both volatile and nonvolatile media, removable and non-removable media. By way of example, and not limitation, computer readable media may comprise computer readable storage media and communication media. Computer readable storage media includes volatile and nonvolatile, as well as removable and non-removable media implemented in any method or technology for storage of information such as computer readable instructions, data structures, program modules or other data. Computer readable storage media includes, but is not limited to, random access memory (RAM), read only memory (ROM), EEPROM, flash memory or other memory technology, CD-ROMs, digital versatile discs (DVDs) or other optical disc storage, magnetic cassettes, magnetic tapes, magnetic disc storage or other magnetic storage devices, or any other medium which can be used to store the information and which can be accessed by a computing device. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as RF and other wireless media. Combinations of any of the above are also included within the scope of computer readable media.

The disclosed technology may be practiced in distributed computing environments where tasks are performed by remote processing devices that are linked through a communications network. In a distributed computing environment, program modules may be located in both local and remote computer storage media including memory storage devices.

For purposes of this document, each process associated with the disclosed technology may be performed continuously and by one or more computing devices. Each step in a process may be performed by the same or different computing devices as those used in other steps, and each step need not necessarily be performed by a single computing device.

For purposes of this document, reference in the specification to “an embodiment,” “one embodiment,” “some embodiments,” or “another embodiment” may be used to described different embodiments and do not necessarily refer to the same embodiment.

For purposes of this document, a connection can be a direct connection or an indirect connection (e.g., via another part).

For purposes of this document, the term “set” of objects, refers to a “set” of one or more of the objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An electronic device for displaying an augmented reality environment, comprising:
a see-through display; and
one or more processors in communication with the see-through display, the one or more processors display content from a web-based resource to an end user using the see-through display, the one or more processors generate tracking information based on eye movement and head movement of the end user as the end user views the content from the web-based resource, the one or more processors identify an active view region of the see-through display based on the tracking information, the one or more processors analyze the web-based resource for the content and a set of display elements associated with the content, the one or more processors identify a point of focus based on correlating the active view region and analyzing the web-based resource, the one or more processors modify the web-based resource based on identifying the point of focus and use a modified portion of the web-based resource to display the content from the web-based resource to the end user through the see-through display.

2. The electronic device of claim 1, wherein:
the one or more processors identify a first portion of the content and one or more display elements corresponding to the first portion of the content as part of identifying the point of focus; and
the one or more processors modify the one or more display elements to generate a visual highlight associated with the first portion of the content as part of modifying the web-based resource.

3. The electronic device of claim 2, wherein:
the one or more processors identify a second portion of the content based on an association of the second portion of the content with the one or more display elements corresponding to the first portion of the content; and
the one or more processors modify the one or more display elements to generate the visual highlight in association with the second portion of the content.

4. The electronic device of claim 3, wherein:
the one or more processors modify the web-based resource by adding one or more additional display elements to the web-based resource, the one or more additional display elements are associated with the first portion of the content.

5. The electronic device of claim 4, wherein:
the one or more processors modify the web-based resource by modifying the first portion of the content and the second portion of the content.

6. The electronic device of claim 1, wherein:
the tracking information includes eye gaze data based on the eye movement of the end user and head direction data based on the head movement of the end user.

7. A method of displaying content using a head-mounted display (HMD), comprising:
displaying content from a plurality of web-based resources to an end user using a see-through display;
generating tracking information based on eye movement and head movement of the end user as the end user views the content from the plurality of web-based resources;
analyzing the content from the plurality of web-based resources to determine article content information;
correlating the article content information from the plurality of web-based resources with the tracking information to generate content preference information for the end user;
accessing an additional web-based resource after generating the content preference information;
modifying the additional web-based resource based on the content preference information; and
displaying content from the additional web-based resource based on a modified portion of the additional web-based resource.

8. The method of claim 7, further comprising:
parsing the additional web-based resource into two or more articles; and
analyzing the content from the two or more articles to generate article content information for each of the two or more articles;
wherein modifying the additional web-based resource includes modifying the additional web-based resource to prioritize a first article over a second article based on correlating the article content information for each of the two or more articles with the content preference information for the end user.

9. The method of claim 8, wherein
correlating the article content information includes determining a correlation between the content preference information and the article content information of the first article that is larger than a correlation between the content preference information and the article content information of the second article.

10. The method of claim 9, wherein prioritizing the first article over the second article comprises:
modifying first the web-based resource such that the see-through display includes a visual highlight for the first article.

11. The method of claim 10, wherein modifying the additional web-based resource comprises:
generating a visual notification for display with the additional web-based resource to alert the end user to the first article and the second article based on comparing the article content of the two or more articles and the content preference information.

12. The method of claim 9, wherein prioritizing the first article over the second article comprises:
displaying the first article using the see-through display at a first depth of view from the end user; and
displaying the second article using the see-through display at a second depth of view from the end user, the second depth of view being larger than the first depth of view.

13. The method of claim 7, further comprising:
accessing the additional web-based resource based on the content preference information for the end user prior to parsing the additional web-based resource.

14. The method of claim 7, wherein the additional web-based resource is a first web-based resource, the method further comprising:
accessing a second additional web-based resource;
displaying content from the second additional web-based resource out of a current field of view of the end user; and
providing an auditory signal using the HMD to indicate a location relative to the user's current field of view of the content from the second additional web-based resource.

15. A computer readable storage medium having computer readable instructions for programming a processor to perform a method comprising:
accessing a web-based resource including content;
accessing tracking information of an end user indicating a first view relative to an augmented reality environment;
displaying the content from the web-based resource based on the first view and a first set of display elements;
accessing additional tracking information of the end user indicating a second view relative to the augmented reality environment, the augmented reality environment including an object obstructing the second view of the content;
generating a second set of display elements based on the additional tracking information to reposition the content relative to the object; and
displaying the content from the web-based resource based on the second view and the second set of display elements.

16. The computer readable storage medium of claim 15, wherein the web-based resource includes an original set of display elements, the method further comprises:
generating the first set of display elements by modifying the original set of display elements based on the tracking information and content preference information of the end user.

17. The computer readable storage medium of claim 15, wherein generating the second set of display elements includes one or more of:
adding a display element to the first set of display elements; and
modifying a display element from the first set of display elements.

18. The computer readable storage medium of claim 15, wherein:
the object is a first virtual object; and
displaying the content from the web-based resource based on the first view and the first set of display elements includes displaying the content in a world-locked view such that the content appears to be displayed on a second virtual object.

19. The computer readable storage medium of claim 15, wherein:
generating the second set of display elements includes replacing at least one CSS element in the first set of display elements.

20. The computer readable storage medium of claim 19, wherein:
replacing the at least one CSS element includes substituting a color based on the augmented reality environment and the object; and
displaying the content from the web-based resource includes one or more of automatically scaling down javascript content and displaying additional content based on the augmented reality environment and the object.
